(19) United States
(12) Patent Application Publication
(10) Pub. No.: US 2019/0009259 A1
(43) Pub. Date: Jan. 10, 2019

(54) LIGANDS AND CATALYSTS

(71) Applicant: OXFORD UNIVERSITY INNOVATION LIMITED, Oxford (GB)

(72) Inventors: Stephen Patrick FLETCHER, Oxford (GB); Zhenbo GAO, Oxford (GB)

(21) Appl. No.: 16/028,634

(22) Filed: Jul. 6, 2018

(30) Foreign Application Priority Data
Jul. 7, 2017 (GB) 1710941.4

(51) Int. Cl. B01J 31/02; C07F 9/6571

(52) U.S. Cl. CPC B01J 31/0264; B01J 2523/17; C07B 2200/07; C07F 9/657154

(57) ABSTRACT

The present invention relates to a compound of formula (I) and salts thereof,

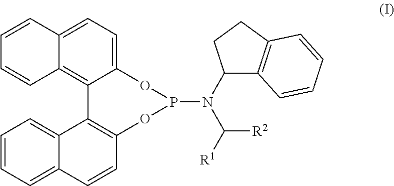

The present invention further relates to catalytic complexes comprising a compound of formula I and uses thereof in the stereoselective synthesis of stereocentres, in particular, all-carbon quaternary stereocentres.

### INTRODUCTION

The present invention relates to compounds of formula I. Compounds of formula I are useful as ligands which when combined with metals provide catalysts suitable for asymmetric synthesis. Accordingly, the present invention also relates to ligands and catalysts, and their use in the stereoselective synthesis of stereocentres, in particular all-carbon, quaternary stereocentres.

### BACKGROUND OF THE INVENTION

The stereoselective formation of all-carbon quaternary stereocentres is a challenging transformation in synthetic chemistry. While a wide variety of methods now exist¹ the synthesis of quaternary centres, particularly in acyclic systems, remains especially difficult. In acyclic systems issues of steric repulsion and conformational control both need to be overcome by the catalyst in order to control enantioselectivity.²

Over the past ten years copper-catalyzed asymmetric conjugate addition (ACA) of alkyl nucleophiles to α,β-unsaturated ketones has emerged as an important route to all-carbon quaternary stereocenters.³

Seminal work by the Alexakis⁴ and Hoveyda⁵ groups has demonstrated that high chemo- and regio- and enantio-selectivities can be obtained using primary sp³-hybridized organometallics such as Grignard reagents^{4d}, dialkylzincs^{5b}, and aluminium reagents⁶. Many examples have now been reported using a variety of catalyst systems, and these reactions are now becoming adapted into the repertoire of synthetic chemists to make important molecules such as natural products and biologically active compounds⁷.

Cu-catalyzed ACAs to form quaternary centres normally rely on the use of cyclic α,β-unsaturated ketones, and although there are sporadic reported examples that use acyclic acceptors, these typically result in lower levels of enantioselectivity⁸.

To the best of our knowledge there are only three highly enantioselective methods for the addition of non-stabilized alkyl nucleophiles to form quaternary stereocentres (FIG. 1). Two of these require highly activated electrophiles: (i) addition of dialkyl zinc reagents to nitro-alkenes as developed by Hoveyda⁹ and expanded by Boehringer Ingelheim¹⁰, and (ii) addition of dialkyl zinc reagents to Meldrum's acid derivatives¹¹.

The third approach uses linear trisubstituted enones, which are normally activated substrates, in combination with aluminium reagents, and is limited to addition of very simple alkyl groups such as Me₃Al or Et₃Al.^{6a,12}

Cu-catalyzed ACAs using alkenes as the equivalents of alkyl nucleophiles have previously been developed. These reactions involve reacting an alkene with the Schwartz reagent (Cp₂ZrHCl) to form an alkylzirconium species in situ which can undergo ACA without the need for cryogenic conditions¹⁴.

Tertiary¹³ and quaternary¹⁵ stereocentres have been prepared by addition to cyclic α,β-unsaturated ketones¹⁶. However, in acyclic substrates, it has proved much more difficult to obtain high enantioselectivity.

However, a method to construct acyclic tertiary centres with up to 91% ee has been previously reported¹⁷.

There is a need in the art for alternative/improved ligands and catalysts capable of yielding all-carbon quaternary stereocentres in good stereoisomeric excess. Suitably, the ligands and catalysts are capable of providing good stereoisomeric excess in acyclic systems. Suitably, the ligands and catalysts are capable of promoting reaction between a wide range of nucleophile and electrophiles, in particular those with bulky substituents and/or bearing functional groups.

### SUMMARY OF THE INVENTION

In a first aspect, the present invention provides a compound of formula I as defined herein.

In a second aspect, the present invention provides a catalyst comprising a metal, a counter ion and a compound of formula I as defined herein.

In a third aspect, the present invention relates to the use of a compound of formula I defined herein, or a catalyst defined herein, for the preparation of a stereocentre in stereoisomeric excess.

In a fourth aspect, the present invention relates to a process for producing a compound possessing a stereocentre in stereoisomeric excess comprising a reaction performed in the presence of compound or catalytic complex as defined herein.

Preferred, suitable, and optional features of any one particular aspect of the present invention are also preferred, suitable, and optional features of any other aspect.

### BRIEF DESCRIPTION OF THE DRAWINGS

FIG. 1 summarises some previously described catalytic, asymmetric addition reactions to activated electrophiles in order to obtain quaternary stereogenic centres.

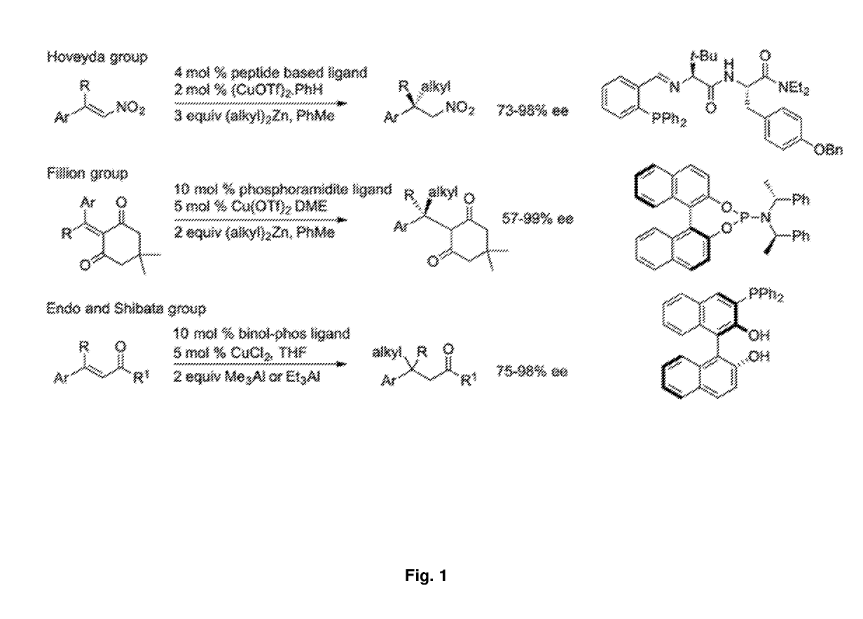

FIG. 2 provides the structures of the ligands used in the examples.

### DETAILED DESCRIPTION OF THE INVENTION

### Definitions

The compounds and intermediates described herein may be named according to either the IUPAC (International Union for Pure and Applied Chemistry) or CAS (Chemical Abstracts Service) nomenclature systems. It should be understood that unless expressly stated to the contrary, the terms “compounds of formula I”, “compounds of formula Ia”, and “compounds of formula Ib” and the more general term “compounds” refer to and include any and all compounds described by and/or with reference to Formula I, Ia and Ib respectively. It should also be understood that, unless explicitly stated/depicted otherwise, these terms encompasses all stereoisomers, i.e. cis and trans isomers, as well as optical isomers, e.g. R and S enantiomers, of such compounds and all salts thereof, in substantially pure form and/or any mixtures of the foregoing in any ratio.

The various hydrocarbon-containing moieties provided herein may be described using a prefix designating the minimum and maximum number of carbon atoms in the moiety, e.g. “(C_{a-b})” or “Cₐ-C_{b}” or “(a-b)C”. For example, (C_{a-b})alkyl indicates an alkyl moiety having the integer “a” to the integer “b” number of carbon atoms, inclusive. Certain moieties may also be described according to the minimum and maximum number of members with or without specific reference to a particular atom or overall structure. For example, the terms “a to b membered ring” or “having between a to b members” refer to a moiety having the integer “a” to the integer “b” number of atoms, inclusive.

“About” when used herein in conjunction with a measurable value such as, for example, an amount or a period of time and the like, is meant to encompass reasonable variations of the value, for instance, to allow for experimental error in the measurement of said value.

As used herein by themselves or in conjunction with another term or terms, “alkyl” and “alkyl group” refer to a branched or unbranched saturated hydrocarbon chain. Unless specified otherwise, alkyl groups typically contain 1-10 carbon atoms, such as 1-6 carbon atoms or 1-4 carbon atoms or 1-3 carbon atoms, and can be substituted or unsubstituted. Representative examples include, but are not limited to, methyl, ethyl, n-propyl, i-propyl, n-butyl, i-butyl, s-butyl, t-butyl, n-pentyl, n-hexyl, n-heptyl, n-octyl, n-nonyl, n-decyl, isopropyl, tert-butyl, isobutyl, etc.

As used herein by themselves or in conjunction with another term or terms, “alkylene” and “alkylene group” refer to a branched or unbranched saturated hydrocarbon chain. Unless specified otherwise, alkylene groups typically contain 1-10 carbon atoms, such as 1-6 carbon atoms or 1-3 carbon atoms, and can be substituted or unsubstituted. Representative examples include, but are not limited to, methylene (—CH₂—), the ethylene isomers (—CH(CH₃)— and —CH₂CH₂—), the propylene isomers (—CH(CH₃)CH₂—, —CH(CH₂CH₃)—, —C(CH₃)₃—, and —CH₂CH₂CH₂—), etc.

As used herein by themselves or in conjunction with another term or terms, “alkenyl” and “alkenyl group” refer to a branched or unbranched hydrocarbon chain containing at least one double bond. Unless specified otherwise, alkenyl groups typically contain 2-10 carbon atoms, such as 2-6 carbon atoms or 2-4 carbon atoms, and can be substituted or unsubstituted. Representative examples include, but are not limited to, ethenyl, 3-buten-1-yl, 2-ethenylbutyl, and 3-hexen-1-yl.

As used herein by themselves or in conjunction with another term or terms, “alkynyl” and “alkynyl group” refer to a branched or unbranched hydrocarbon chain containing at least one triple bond. Unless specified otherwise, alkynyl groups typically contain 2-10 carbon atoms, such as 2-6 carbon atoms or 2-4 carbon atoms, and can be substituted or unsubstituted. Representative examples include, but are not limited to, ethynyl, 3-butyn-1-yl, propynyl, 2-butyn-1-yl, and 3-pentyn-1-yl.

As used herein by themselves or in conjunction with another term or terms, “cycloalkyl” and “cycloalkyl group” refer to a non-aromatic carbocyclic ring system, that may be monocyclic, bicyclic, or tricyclic, saturated or unsaturated, and may be bridged, spiro, and/or fused. A cycloalkyl group may be substituted or unsubstituted. Unless specified otherwise, a cycloalkyl group typically contains from 3 to 12 ring atoms. In some instances a cycloalkyl group may contain 4 to 10 ring atoms (e.g., 4 ring atoms, 5 ring atoms, 6 ring atoms, 7 ring atoms, etc.). Representative examples include, but are not limited to, cyclopropyl, cyclopropenyl, cyclobutyl, cyclobutenyl, cyclopentyl, cyclopentenyl, cyclohexyl, cyclohexenyl, norbornyl, norbornenyl, bicyclo[2.2.1]hexane, bicyclo[2.2.1]heptane, bicyclo[2.2.1]heptene, bicyclo[3.1.1]heptane, bicyclo[3.2.1]octane, bicyclo[2.2.2]octane, bicyclo[3.2.2]nonane, bicyclo[3.3.1]nonane, and bicyclo[3.3.2]decane.

As used herein, the term “stereocentre” or “stereogenic centre” may refer to a central asymmetric atom, or chrial centre, bonded to groups each distinguishable from one another. Interchange of any two of said groups provides a different stereoisomer.

As used herein, the term “all-carbon quaternary stereocentre” refers to a stereogenic centre wherein a central asymmetric carbon atom is bonded to four distinguishable substituents via a C—C bond.

As used herein, the term “stereoisomeric excess” encompasses diastereomeric excess and enantiomeric excess.

As used herein, the term “acyclic system” in relation to a stereocentre means that the stereocentre does not form part of a cyclic system, e.g. a cycloalkyl ring.

As used herein, the term “enantiopure” means that substantially all molecules in the sample have the same chirality sense. Suitably, the stereoisomeric exess in an enantiopure compound of the invention is about 98% or more, more suitably about 99% or more, more suitably 100% to within the limits of detection.

As used herein, the term “enantioenriched” means that the sample is stereochemcially enriched such that the one stereoisomer is in stereoisomer excess (i.e. the stereoisomer ratio is greater than 50:50). Suitably, an enantioenriched compound of the present invention has a stereoisomeric excess of about 70% or greater, suitably about 80% or greater, suitably about 85% or greater, suitably about 90% or greater, suitably about 95% or greater.

### Compounds of Formula I

In one aspect, the present invention relates to a compound of formula I and salts thereof,

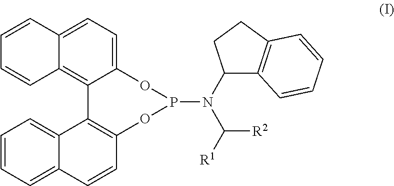

wherein

R¹ and R² are the same or different and selected from a C₂ to C₁₂ alkyl group; or

R¹ and R² together with the carbon atom to which they are attached form a C₇ to C₂₀ cycloalkyl group.

Those skilled in the art will appreciate that the binaphthol moiety of formula I has a stereogenic centre and exhibits axial chirality. In one embodiment, the binaphthol moiety of formula I is non-racemic. In one embodiment, the binaphthol moiety is enantioenriched. In another embodiment, the binaphthol moiety is enantiopure.

In one embodiment, the binaphthol moiety is the (R)-enantiomer. In another embodiment, the binaphthol moiety is the (S)-enantiomer. Accordingly, the compounds of formula I in one embodiment can be represented by sub-formulae Ia and Ib:

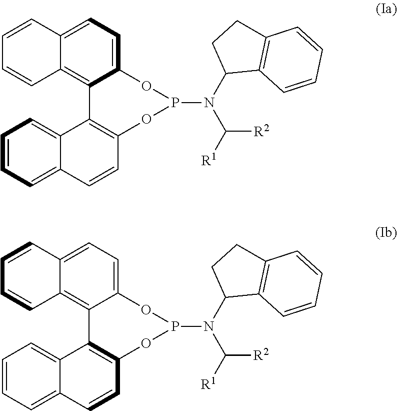

In one embodiment, of compounds of formula I, Ia and Ib, the stereogenic centre on the indane moiety is non-racemic. In one embodiment, the stereogenic centre on the indane moiety is enantioenriched. In another embodiment, the stereogenic centre of the indane moiety is enantiopure.

Suitably, in one embodiment, the stereogenic centre on the indane is in the (R)-configuration. Alternatively, in one embodiment, the stereogenic centre on the indane is in the (S)-configuration.

In one embodiment, the compound of formula (I) is the (R,R)-stereoisomer with respect to the stereogenic centres on the binaphthol moiety and the indane moiety. In another embodiment, the compound of formula (I) is the (S,S)-stereoisomer with respect to the stereogenic centres on the binaphthol moiety and the indane moiety.

In one embodiment, the compounds of formula I can be represented by sub-formulae Ia′ and Ib′:

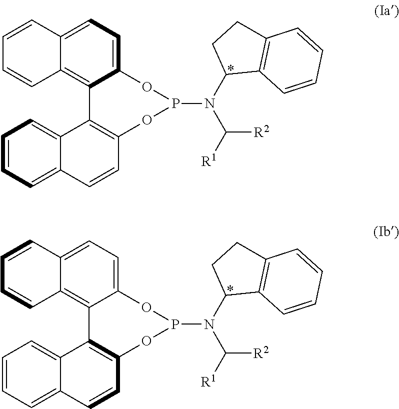

wherein the * indicates that the adjacent asymmetric carbon atom is either in the (S) or (R) configuration.

In one embodiment, R¹ and R² are the same or different and selected from a C₂ to C₁ alkyl group. Suitably, R¹ and R² are the same or different and selected from a C₂ to C₁₀ alkyl group, or a C₂ to C₉ alkyl group, C₂ to C₈ alkyl group, C₂ to C₇ alkyl group, C₂ to C₆ alkyl group, C₂ to C₅ alkyl group, C₂ to C₄ alkyl group.

In one of embodiment, R¹ and R² are the same and selected from C₂ to C₁₁ alkyl group. Suitably, R¹ and R² are the same and selected from a C₂ to C₁₀ alkyl group, or a C₂ to C₉ alkyl group, or a C₂ to C₈ alkyl group, or a C₂ to C₇ alkyl group, or a C₂ to C₆ alkyl group, or a C₂ to C₅ alkyl group, or a C₂ to C₄ alkyl group.

In one of embodiment, R¹ and R² are the same or different and selected from C₃ to C₁₂ alkyl group. Suitably, R¹ and R² are the same or different and selected from a C₃ to C₁₁ alkyl group, or a C₃ to C₁₀ alkyl group, or a C₃ to C₉ alkyl group, or a C₃ to C₈ alkyl group, or a C₃ to C₇ alkyl group, or a C₃ to C₆ alkyl group, or a C₃ to C₅ alkyl group, or a C₃ to C₄ alkyl group.

In one of embodiment, R¹ and R² are the same and selected from C₃ to C₁₂ alkyl group. Suitably, R¹ and R² are the same and selected from a C₃ to C₁₁ alkyl group or a C₃ to C₁₀ alkyl group, or a C₃ to C₉ alkyl group, or a C₃ to C₈ alkyl group, or a C₃ to C₇ alkyl group, or a C₃ to C₆ alkyl group, or a C₃ to C₅ alkyl group, or a C₃ to C₄ alkyl group.

In one of embodiment, R¹ and R² are the same or different and selected from C₄ to C₁₂ alkyl group. Suitably, R¹ and R² are the same or different and selected from a C₄ to C₁₁ alkyl group, or a C₄ to C₁₁ alkyl group or a C₄ to C₁₀ alkyl group, or a C₄ to C₉ alkyl group, or a C₄ to C₈ alkyl group, or a C₄ to C₇ alkyl group, or a C₄ to C₆ alkyl group, or a C₄ to C₅ alkyl group.

In one of embodiment, R¹ and R² are the same and selected from C₄ to C₁₂ alkyl group. Suitably, R¹ and R² are the same and selected from a C₄ to C₁₁ alkyl group, or a C₄ to C₁₁ alkyl group or a C₄ to C₁₀ alkyl group, or a C₄ to C₉ alkyl group, or a C₄ to C₈ alkyl group, or a C₄ to C₇ alkyl group, or a C₄ to C₆ alkyl group, or a C₄ to C₅ alkyl group.

In one embodiment, R¹ and R² are the same or different and selected from C₂ to C₁₀ alkyl group; or R¹ and R² together with the carbon atom to which they are attached form a C₇ to C₁₄ cycloalkyl group.

In one embodiment, R¹ and R² are the same or different and selected from C₂ to C₈ alkyl group; or R¹ and R² together with the carbon atom to which they are attached form a C₇ to C₁₀ cycloalkyl group.

In one embodiment, R¹ and R² are the same or different and selected from C₂ to C₆ alkyl group; or R¹ and R² together with the carbon atom to which they are attached form a C₇ to C₉ cycloalkyl group.

In one embodiment, R¹ and R² are the same or different and selected from C₄ alkyl group; or R¹ and R² together with the carbon atom to which they are attached form a C₇ or a C₈ cycloalkyl group.

In one embodiment, R¹ and R² are the same or different and selected from a C₄ alkyl group.

In one embodiment, R¹ and R² are both unbranched alkyl groups.

In one embodiment, R¹ and R² are independently selected from ethyl, n-propyl, i-propyl, n-butyl, s-butyl, and i-butyl. Suitably, R¹ and R² are independently selected from ethyl, n-propyl and n-butyl.

In one embodiment, R¹ and R² are independently selected from n-butyl, s-butyl, and i-butyl.

In one embodiment, R¹ and R² are the same and selected from ethyl, n-propyl, i-propyl, n-butyl, s-butyl, and i-butyl. Suitably, R¹ and R² are the same and selected from ethyl, n-propyl and n-butyl.

In one embodiment, R¹ and R² are both n-butyl.

In one embodiment, R¹ and R² together with the carbon atom to which they are attached form a C₇ to C₁₉ cycloalkyl group. Suitably, R¹ and R² together with the carbon atom to which they are attached form a C₇ to C₁₉ cycloalkyl group, or a C₇ to C₁₈ cycloalkyl group, a C₇ to C₁₇ cycloalkyl group, a C₇ to C₁₆ cycloalkyl group, a C₇ to C₁₅ cycloalkyl group, a C₇ to C₁₄ cycloalkyl group, a C₇ to C₁₃ cycloalkyl group, a C₇ to C₁₂ cycloalkyl group, a C₇ to C₁₁ cycloalkyl group, a C₇ to C₁₀ cycloalkyl group, a C₇ to C₉ cycloalkyl group, a C₇ to C₈ cycloalkyl group.

In one embodiment, R¹ and R² together with the carbon atom to which they are attached form a monocyclic cycloalkyl group.

In one embodiment, R¹ and R² together with the carbon atom to which they are attached form a saturated cycloalkyl group, suitably a saturated, monocyclic cycloalkyl group

In one embodiment, R¹ and R² together with the carbon atom to which they are attached form a cyclooctane ring, a cyclononane ring or a cyclodecane ring. Suitably, R¹ and R² together with the carbon atom to which they are attached form a cyclooctane ring or a cyclononane ring.

In one embodiment, R¹ and R² are the same and selected from ethyl, n-propyl, i-propyl, n-butyl, s-butyl, and i-butyl, or R¹ and R² together with the carbon atom to which they are attached form a cyclooctane ring, a cyclononane ring or a cyclodecane ring.

In one embodiment, R¹ and R² are the same and selected from ethyl, n-propyl and n-butyl, or R¹ and R² together with the carbon atom to which they are attached form a cyclooctane ring or a cyclononane ring.

In one embodiment, the compound of formula (I) is selected from one of the following:

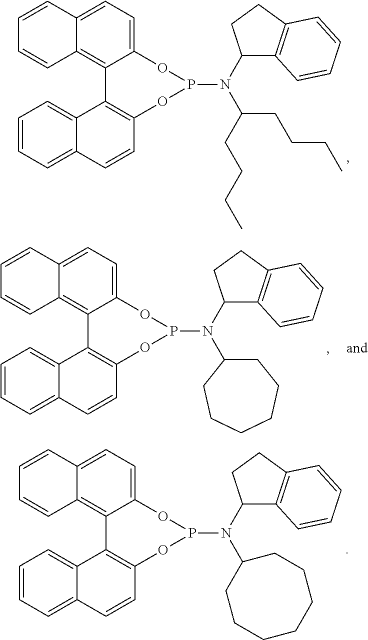

In one embodiment, the compound of formula (I) is selected from one of the following:

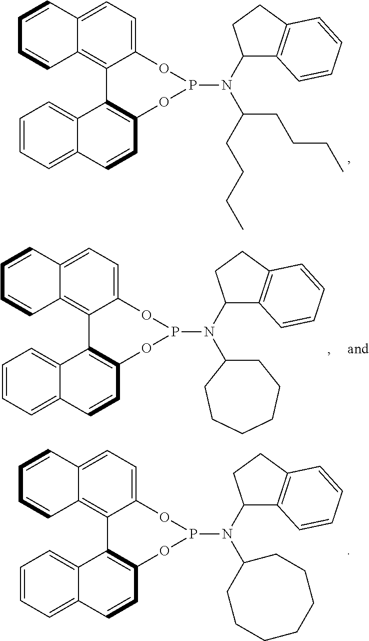

In one embodiment, the compound of formula (I) is selected from one of the following:

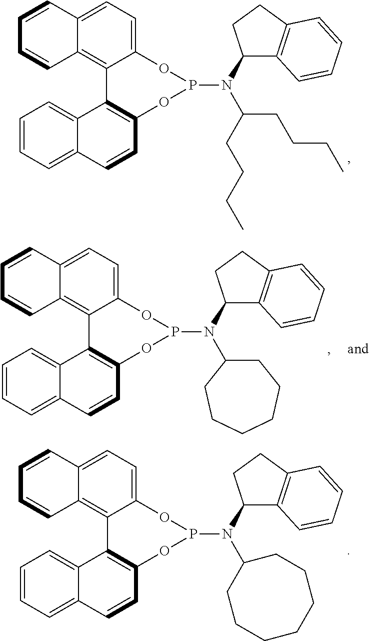

In one embodiment, the compound of formula (I) is selected from one of the following:

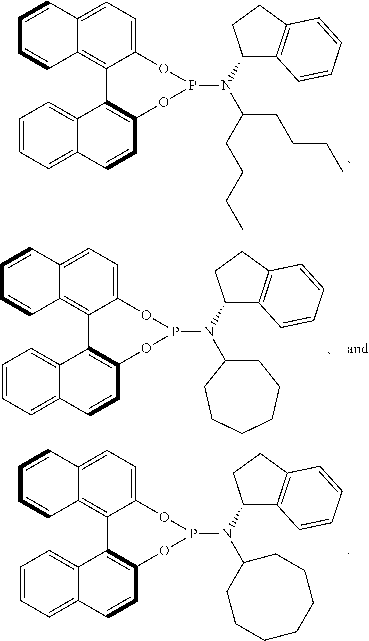

In one embodiment, the compound of formula (I) is selected from one of the following:

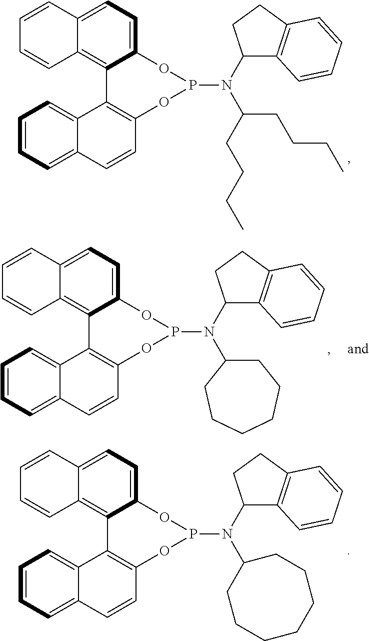

In one embodiment, the compound of formula (I) is selected from one of the following:

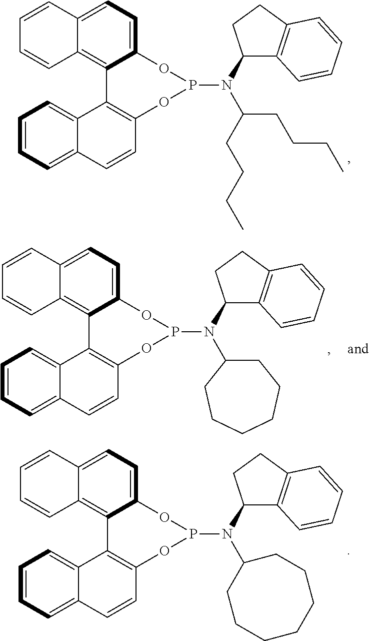

In one embodiment, the compound of formula (I) is selected from one of the following:

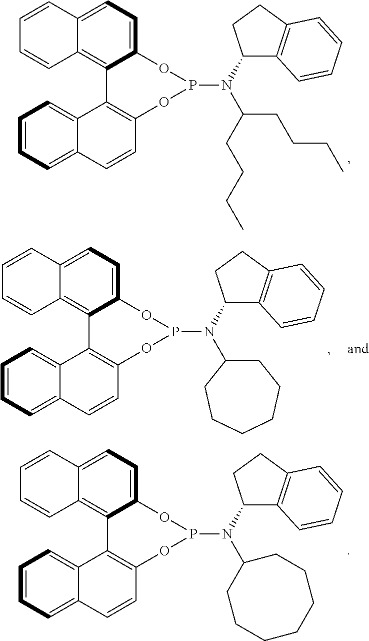

### Catalytic Complex

In another aspect, the present invention relates to a catalytic complex comprising a metal, a counter ion and a compound of formula I as defined herein and according to any of the above mentioned embodiments.

Suitably, the counterion serves to provide electroneutrality to the catalytic complex and will typically be a non-coordinating counterion. In one embodiment, the couterion is a triflate anion (⁻OTf). Typically, only one counterion (e.g. a triflate counterion) is present in the catalytic complex.

In one embodiment, the metal is a transition metal. Suitably, the metal is selected from copper, cobalt, iridium, rhodium, ruthenium, nickel, iron, palladium, gold, silver and platinum.

In one embodiment, the complex comprises copper. Suitably, the metal is copper (I). The use of copper is particularly desirable as it can catalyse the conjugate addition of alkylzirconocenes formed in situ from alkenes with high overall yield.

The catalytic complex comprises one or more ligands, at least one of which is a compound of formula I. Suitably, the compound of formula I is chiral and non-racemic. Suitably, the compound of formula I is enantiomerically and/or diastereomerically enriched. Suitably, the compound of formula I is enantiomerically and/or diastereomerically pure.

The one or more ligands will normally be bound to the metal atom via a coordinate bond. Typically, the one or more ligands will be uncharged such that they do not counter the ionic charge of any other species in the complex.

The catalytic complex may be prepared following procedures known in the art. The catalytic complex will generally be prepared by contacting a metal and a compound of the invention with a counterion (such as a triflate anion). The counterion is preferably in the form of a metal salt, suitably a silver salt. In an embodiment, the counterion is added in the form of a silver triflate.

The complex may be formed as a pre-made catalyst or may be generated in situ during the course of a chemical reaction.

The complex may be prepared by stirring the metal, one or more ligands, one or more counterions and any other components under appropriate conditions. Suitable processes and conditions for forming the catalytic complexes of the present invention are described in the Examples herein. By way of illustration, and without limitation, a catalytic complex comprising copper, a compound of formula I and a triflate counterion may be prepared according to the following procedure. A copper salt and one equivalent of a compound of formula I are added to a dry Schlenk flask, at room temperature under an inert atmosphere. Dry dichloromethane (DCM) is then added and the mixture is stirred to create a solution. Silver triflate is added to the solution and stirred. The resulting mixture is filtered and the solvent. The resulting solid is dried and is then stored under argon.

In one embodiment, the catalytic complex is selected from:

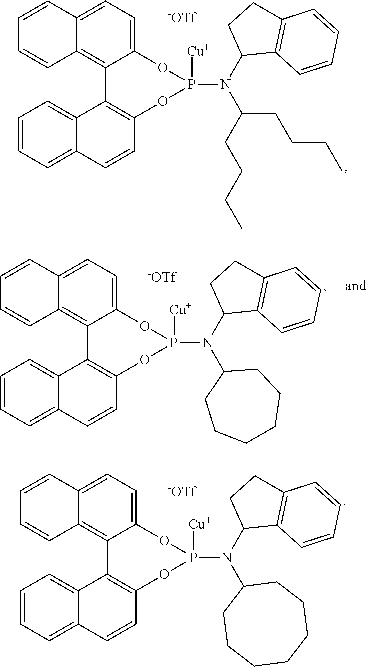

In one embodiment, the compound of formula (I) is selected from one of the following:

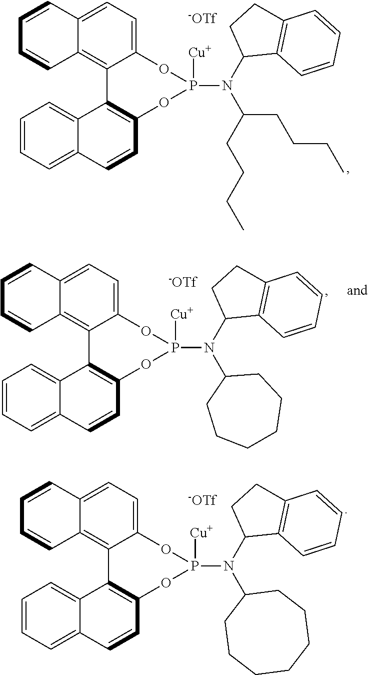

In another embodiment, the catalytic complex is selected from:

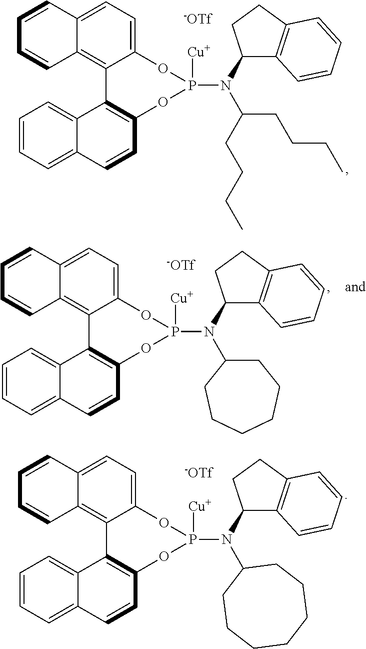

In another embodiment, the catalytic complex is selected from:

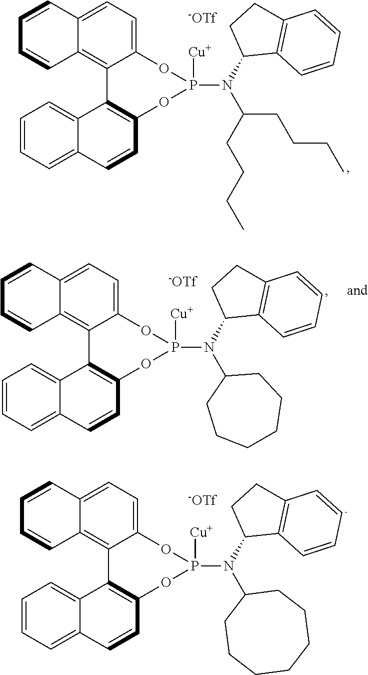

In another embodiment, the catalytic complex is selected from:

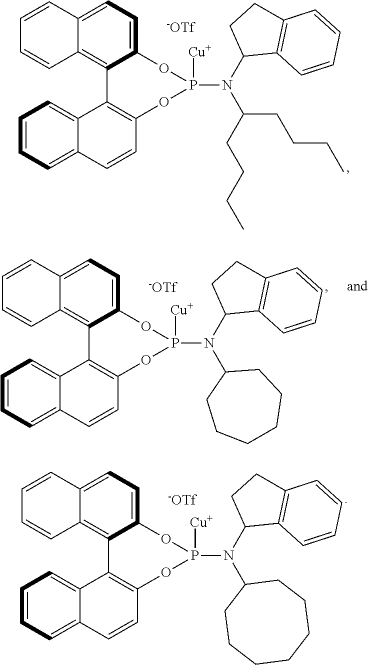

In one embodiment, the catalytic complex is selected from one of the following:

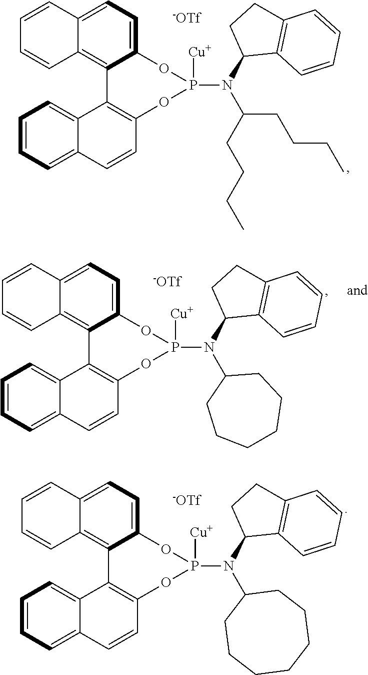

In one embodiment, the catalytic complex is selected from one of the following:

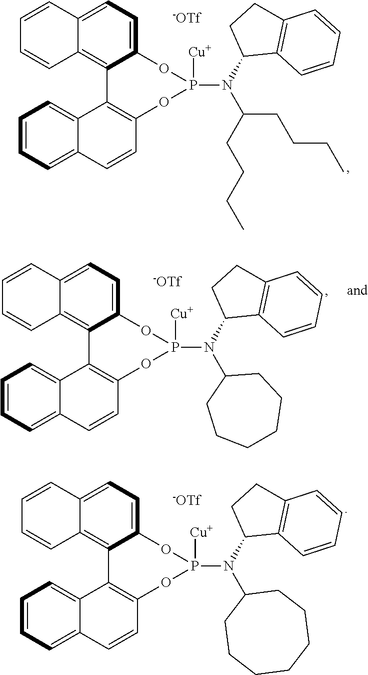

### Uses and Processes

The catalytic complexes and compounds of the present invention may be used in processes for the production of compounds possessing a stereocentre (e.g. chiral compounds) in a stereoisomeric excess (e.g. an enantiomeric excess or a diastereomeric excess). In particular, the catalytic complexes may be used in processes for the asymmetric synthesis of chiral compounds, e.g. in processes which involve an asymmetric 1,4-conjugate addition reaction or an asymmetric 1,6-conjugate addition reaction. Examples of such processes are described in PCT Patent Application No. PCT/GB2012/052537, filed 12 Oct. 2012 and entitled “Asymmetric Synthesis of Organic Compounds”, the contents of which are incorporated herein by reference in their entirety.

In one aspect, the present invention relates to the use of a compound of formula I described in any of the aspects or embodiment above, or a catalyst according to any of the aspects and embodiments above, for the preparation of stereocentre in stereoisomeric excess. Suitably, said use is for the preparation of an all-carbon stereocentre in stereoisomeric excess. Suitably, said use is for the preparation of an all-carbon quaternary stereocentre in stereoisomeric excess.

In another aspect, the present invention relates a process for producing a compound possessing a stereocentre in stereoisomeric excess comprising a reaction performed in the presence of compound or catalytic complex as defined herein. Suitably, said process is for the preparation of an all-carbon stereocentre in stereoisomeric excess. Suitably, said process is for the preparation of an all-carbon quaternary stereocentre in stereoisomeric excess.

Suitably, the steroisomeric excess is greater than about 80%, more suitably greater than about 85%, more suitably greater than about 90%, more suitably greater than about 91%, more suitably greater than about 92%, more suitably greater than about 93%, more suitably greater than about 94%, more suitably greater than about 95%, more suitably greater than about 96%, more suitably greater than about 97%, more suitably greater than about 98%.

Suitably, the steroisomeric excess is from about 80% to about 98%, more suitably about 85% to about 98%, more suitably about 90% to about 98%, more suitably about 91% to about 98%, more suitably about 92% to about 98%, more suitably about 93% to about 98%, more suitably about 94% to about 98%, more suitably about 95% to about 98%.

Suitably, the steroisomeric excess is from about 80% to about 96%, more suitably about 85% to about 96%, more suitably about 90% to about 96%, more suitably about 91% to about 96%, more suitably about 92% to about 96%, more suitably about 93% to about 96%.

Suitably, the steroisomeric excess is from about 80% to about 95%, more suitably about 85% to about 95%, more suitably about 90% to about 95%, more suitably about 91% to about 95%, more suitably about 92% to about 95%, more suitably about 93% to about 95%.

Suitably, the steroisomeric excess is from about 80% to about 94%, more suitably about 85% to about 94%, more suitably about 90% to about 94%, more suitably about 91% to about 94%, more suitably about 92% to about 94%.

Suitably, the steroisomeric excess is from about 80% to about 93%, more suitably about 85% to about 93%, more suitably about 90% to about 93%, more suitably about 91% to about 93%, more suitably about 92% to about 93%.

In one embodiment, the stereocentre is part of a cyclic or acyclic system. In one embodiment, the stereocentre is part of an acyclic system.

In one embodiment, the all-carbon quaternary stereocentre is part of a cyclic or acyclic system. In one embodiment, the all-carbon quaternary stereocentre is part of an acyclic system.

In one embodiment, the process of the present invention comprises:

(i) contacting a first compound comprising an alkene bond with a hydrometallating agent, wherein the first compound and the hydrometallating agent are contacted under conditions such that the first compound is hydrometallated by said hydrometallating agent; and
(ii) contacting the hydrometallated first compound with a second compound, wherein the second compound comprises a conjugated n-bond system which is capable of undergoing a 1,4-conjugate addition reaction or a 1,6-conjugate addition reaction and which has a carbon atom at said 4-position or said 6-position respectively, wherein the hydrometallated first compound and the second compound are contacted under conditions such that they undergo an asymmetric 1,4-conjugate addition reaction or an asymmetric 1,6-conjugate addition reaction in which a carbon atom of said hydrometallated first compound binds to the carbon atom at said 4-position or said 6-position of the second compound, forming an all-carbon stereogenic centre at the 4-position or 6-position in stereoisomeric excess;

wherein said asymmetric 1,4-conjugate addition reaction or said asymmetric 1,6-conjugate addition reaction is performed in the presence of a compound or catalytic complex of the present invention.

The first compound comprises at least one alkene bond, i.e. at least one aliphatic carbon-carbon double (C═C) bond. The first compound may be an acyclic compound, a cyclic compound, or may comprise an acyclic portion and a cyclic portion. The compound may consist exclusively of carbon and hydrogen atoms, or may comprise one or more other atoms in addition.

In an embodiment, the first compound is a straight or branched alkene compound having from 2 to 30 carbon atoms, e.g. from 2 to 20 carbon atoms, e.g. from 2 to 12 carbon atoms, e.g. from 2 to 10 carbon atoms, e.g. 2, 3, 4, 5 or 6 carbon atoms. The alkene compound may be unsubstituted or substituted with one or more substituents, e.g. with 1, 2, 3, 4 or 5 substituents selected from alkyl, cycloalkyl, halogen, hydroxyl and ether groups.

Suitably, the first compound is a terminal alkene.

The first compound is reacted with a hydrometallating agent under conditions such that the first compound is hydrometallated. Hydrometallation of the first compound will typically result in the addition of a metal atom to one carbon atom of the alkene bond and a hydride ligand to the other. In certain instances, the first compound may undergo one or more intramolecular rearrangements (e.g. beta hydride elimination followed by further hydrometallation) in which the alkene bond relocates to a different position within the first compound, prior to or during reaction with the hydrometallating agent. Thus, for instance, the hydrometallation reaction may result in the attachment of the metal at the sterically less hindered position of the alkene chain. In this case, hydrometallation may occur either by regiospecific addition of the agent to a terminal alkene bond or by addition of the agent to an internal alkene bond followed by rearrangement via metal hydride elimination and readdition to place the metal at a less hindered position of the alkene chain (see e.g. Schwartz et al, Angew. Chem. Int. Ed., 1976, 6, 333). All such hydrometallation reactions fall within the scope of the present invention.

Various hydrometallating agents are known in the art. The hydrometallating agent may comprise a metal (which term encompasses metalloids) and at least one hydride group.

By way of illustration, the hydrometallating agent may comprise at least one metal selected from zirconium, titanium, hafnium, niobium, tantalum, boron, aluminium, tin, silicon, magnesium, zinc, palladium, iridium, copper, rhodium, ruthenium, platinum, rhenium, nickel and the like. Preferably, the hydrometallating agent comprises a transition metal. More preferably, the hydrometallating agent comprises zirconium. The hydrometallating agent may be in the form of a metal complex comprising a metal (e.g. a transition metal) bound to one or more ligands, at least one of which is a hydride ligand.

In a preferred embodiment, the hydrometallating agent is a zirconium complex, e.g. a zirconium halohydride complex. In an embodiment, the hydrometallating agent is a zirconium complex of the formula HZrR₂X, wherein each R is independently an optionally substituted 6n electron donating ligand (e.g. having 5 carbon atoms, e.g. a π-cyclopentadienyl ligand) and X is another ligand, e.g. selected from halogen, triflates, alcohols and nitrogen-containing compounds. In a preferred embodiment, the hydrometallating agent is a zirconium complex of the formula HZrCp₂X, wherein each Cp is an optionally substituted π-cyclopentadienyl ligand and X is a ligand selected from halogen, triflates, alcohols and nitrogen-containing compounds. Preferably, X is halogen. Particularly preferred is a zirconium complex of the formula HZrCp₂Cl, which is commonly known in the art as the “Schwartz reagent” (see Schwartz et al, J. Am. Chem. Soc, 96, 81 15-8116, 1974).

The hydrometallating agent may be prepared according to procedures known in the art (see e.g. Org. Syn., coll. Col. 9, p. 162 (1998), vol. 71, p 77 (1993); Negishi, Tet. Lett. 1984, 25, 3407; Buchwald, Tet. Lett. 1987, 28, 3895; Lipshutz, Tet. Lett., 1990, 31, 7257; Negishi, J. Org. Chem. 1991, 56, 2590; and Negishi, Eur. J. Org. Chem. 1999, 969).

The hydrometallated first compound is reacted with a second compound, the second compound comprising a conjugated n-bond system which is capable of undergoing a 1,4-conjugate addition reaction or a 1,6-conjugate addition reaction and which has a carbon atom at the 4- or the 6-position respectively. The second compound may be any compound capable of acting as a so-called “Michael acceptor”, and will typically be an electrophilic alkene compound. Exemplary compounds include α,β-unsaturated carbonyl compounds (e.g. enones, acrylate esters, acrylamides, maleimides, alkyl methacrylates, acrylamides and vinyl ketones), cyanoacrylates, vinyl sulfones, nitro ethylenes, vinyl phosphonates, acrylonitriles, vinyl pyridines and azo compounds. In a preferred embodiment, the second compound is an α,β-unsaturated carbonyl compound, e.g. an enone.

In one embodiment, the reaction mixture also comprises a silyl halide, suitably a silyl chloride, more suitably trimethylsilyl chloride (TMSCl).

In one embodiment, the reaction is performed in a solvent. Suitably, the solvent is selected from DCM, THF and diethyl ether, more suitably diethyl ether.

In one embodiment, the product of the reaction possesses an all-carbon quaternary stereocentre at the 4- or 6-position in stereoisomeric excess.

### EXAMPLES

Materials

Unless stated otherwise, commercially available reagents were purchased from Sigma-Aldrich, Fisher Scientific, Apollo Scientific, Acros Organics, Strem Chemicals, Alfa Aesar or TCI UK and were used without purification.

Petroleum ether refers to light petroleum boiling in the range 40-60° C. TMSCl was distilled before use and stored in Schlenk flasks under an argon atmosphere. Deuterated solvents were purchased from Sigma-Aldrich (CD₂Cl₂, CDCl₃). The Schwartz reagent was prepared according to a literature procedure (see Buchwald et al, Org. Synth., 1993, 71, 77-82) from Cp₂ZrCl₂ provided by Strem Chemicals. (CuOTf)₂.C₆H₆ was synthesised using a modified literature procedure (see Salomon et al, J. Am. Chem. Soc, 1973, 95(6), 1889-1897) and carefully maintained under an inert atmosphere. (CuOTf)₂.C₆H₆ was a white or off-white powder, not green or brown.

Certain enone substrates were synthesised according to literature procedures (see Martin et al, J. Am. Chem. Soc, 2006, 128(41), 13368-13369; and Vuagnoux-d'Augustin et al, Chem. Eur. J., 2007, 13(34), 9647-9662).

Dry THF, CH₂Cl₂, Et₂O, PhMe, benzene, hexane, DME were collected fresh from an mBraun SPS-800 solvent purification system having been passed through anhydrous alumina columns. Dry tert-butyl methyl ether and 2-Me-THF were purchased from Acros with an AcroSeal®. All other dry solvents used were dried over 3A molecular sieves and stored under argon. All other solvents were used as purchased from Sigma Aldrich, Rathburn or Fisher Scientific. 1,2-Dichloroethane was distilled before use.

### Methods

Procedures using oxygen- and/or moisture-sensitive materials were performed with anhydrous solvents under an atmosphere of anhydrous argon in flame-dried flasks, using standard Schlenk techniques.

Analytical thin-layer chromatography was performed on precoated glass-backed plates (Silica Gel 60 F254; Merck), and visualised using a combination of UV light (254 nm) and aqueous eerie ammonium molybdate (CAM), aqueous basic potassium permanganate stains or vanillin solution. Flash column chromatography was carried out using Apollo Scientific silica gel 60 (0.040-0.063 nm), Merck 60 A silica gel, VWR (40-63 m) silica gel, Sigma Aldrich silica gel. Pressure was applied at the column head via hand bellows or a flow of nitrogen with a solvent system.

Cooling of reaction mixtures to 0° C. was achieved using an ice-water bath. Other temperatures were obtained using a Julabo FT902 immersion cooler.

Unless stated otherwise, solution NMR spectra were recorded at room temperature. ¹H and ¹³C nuclear magnetic resonance experiments were carried out using Bruker DPX-200 (200/50 MHz), AVN-400 (400/100 MHz), DQX-400 (400/100 MHz) or AVC-500 (500/125 MHz) spectrometers. Chemical shifts are reported in ppm from the residual solvent peak. Chemical shifts (6) are given in ppm and coupling constants (J) are quoted in hertz (Hz). Resonances are described as s (singlet), d (doublet), t (triplet), q (quartet) and m (multiplet). Labels H and H′ refer to diastereotopic protons attached to the same carbon and impart no stereochemical information. Assignments were made with the assistance of gCOSY, DEPT-135, gHSQC and gHMBC or gHMQC NMR spectra.

Low-resolution mass spectra were recorded using a Walters LCT premier XE. High resolution mass spectra (EI and ESI) were recorded using a Bruker MicroTOF spectrometer.

Infrared measurements (neat, thin film) were carried out using a Bruker Tensor 27 FT-I R with internal calibration in the range 4000-600 cm⁻¹. Optical rotations were recorded using a Perkin-Elmer 241 Polarimeter.

Solutions were filtered using syringe filters PTFE (0.2 pm, 13 mm diameter) from Camlab.

Unless stated otherwise compounds of formula I may be prepared by the following procedure:

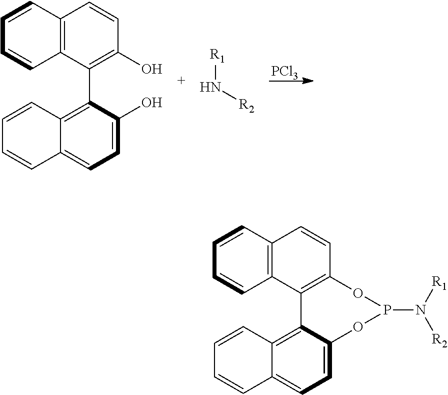

Triethylamine (5.0 eq.) was added dropwise to a stirred, ice-cooled solution of PCl₃ (1.0 eq.) in CH₂Cl₂. The ice bath was removed and the solution left to warm to room temperature before amine (1.0 eq.) was added to the stirred solution in one portion. After 5 hours, binaphthol (1.0 eq.) was tipped into the suspension and the reaction mixture was left to stir for another 15 hours. The mixture was then filtered over an 2 cm pad of celite and silica gel, and CH₂Cl₂ was used to rinse the pad. The filtrate was concentrated to give a yellow residue and after flash column chromatography (petroleum ether: CH₂Cl₂: Et₃N, 80:20:1; SiO₂) the ligand was obtained as a white crystalline solid.

Unless stated otherwise compounds possessing all-carbon quaternary centres were prepared by the following procedure:

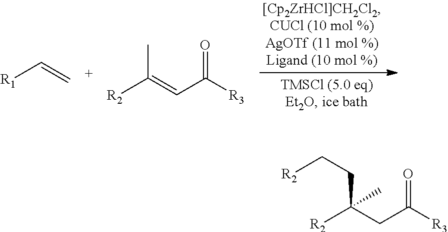

CuCl (0.1 eq.), and the phosphoramidite ligand (0.1 eq.) were added to a flame dried round bottom flask containing 1 mL Et₂O under argon and the resulting mixture was stirred at room temperature. After 1 hour, AgOTf (0.11 eq.) was added and the mixture was stirred for an additional 15 min. To a second, flame dried, round bottom flask, containing a stirred solution of alkene (2.5 eq.) in CH₂Cl₂, under an argon atmosphere was added Cp₂ZrHCl (2.0 eq.), and after stirring for 15 min, a clear yellow solution was obtained. The stirred solution containing the copper and ligand was transferred, and filtered—using a syringe filter, to the solution containing the zirconocene species. The resulting black mixture was stirred for another 10 min before enone and TMSCl were sequentially added dropwise over about 1 min for each. Stirring at 0° C. was continued for 15 additional hours, before the reaction was quenched by the addition of NH₄Cl (sat. aq.) and then Et₂O. The reaction mixture was partitioned between the aqueous and organic phases, and the aqueous layer extracted by Et₂O. The combined organic materials were dried (Na₂SO₄), filtered, concentrated, and the resulting yellow residual purified by flash column chromatography (Petrol: Et₂O; 90:10; SiO₂) to give the desired product.

In some instances, enantiomeric excess (ee) was determined by HPLC analysis. Chiral HPLC separations were achieved using an Agilent 1230 Infinity series normal phase HPLC unit and HP Chemstation software. Chiralpak® columns (250×4.6 mm), fitted with matching Chiralpak® Guard Cartridges (10×4 mm), were used as specified in the text. Solvents used were of HPLC grade (Fisher Scientific, Sigma Aldrich or Rathburn); all eluent systems were isocratic.

### Example 1—Synthesis of (+)-(11bS)—N—((S)-2,3-dihydro-1H-inden-1-yl)-N-(nonan-5-yl)dinaphtho[2,1-d:1′,2′-f][1,3,2]dioxaphosphepin-4-amine (Ligand B)

### (+)-(S)—N-(nonan-5-yl)-2,3-dihydro-1H-inden-1-amine

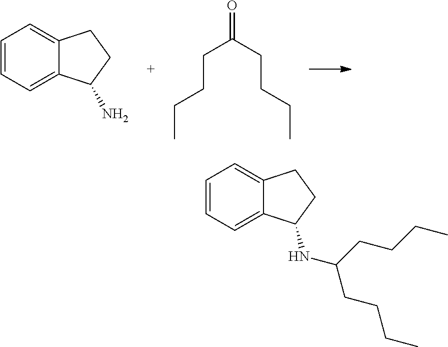

TiCl₄ (3.9 mL (1 M solution in CH₂Cl₂), 1.1 eq, 3.9 mmol), was added slowly to an ice-cooled solution of 2-nonan-5-one (1.33 mL, 1.0 eq, 7.7 mmol) in CH₂Cl₂. The solution was stirred for 10 minutes at room temperature and then a 2 M solution of (S)-(+)-1-Aminoindane (0.45 mL, 2.2 eq, 3.5 mmol), in THF was added dropwise to the reaction mixture. The reaction mixture was stirred for 3 hours before a 1 M solution of NaB(CN)H₃ (1.2 eq.) in THF, and then MeOH (10 mL) were added slowly to the reaction mixture and stirring at room temperature was continued for 48 hours. NaOH (2M aq. solution) was added slowly and the mixture was stirred for 30 min before filteration over celite and washing with EtOAc (30 mL). The mixture was partitioned between the aqueous and organic layers and the aqueous phase extracted with EtOAc (3 times). The combined organic phase was dried (MgSO₄), filtered and concentrated in vacuo to afford a yellow oil. Flash column chromatography of the residue (96:4 CHCl₃: MeOH, SiO₂) gave the desired amine, (0.90 g, 98%).

¹H NMR (400 MHz, Chloroform-d) δ_{H}/ppm 7.40-7.31 (m, 1H, Ar—H), 7.28-7.13 (m, 3H, Ar—H), 4.28 (t, J=6.8 Hz, 1H, PhCHNH), 2.98 (ddd, J=15.8 Hz, 8.5 Hz, 4.1 Hz, 1H, PhCH₂), 2.91-2.76 (m, 1H, PhCH₂), 2.76-2.68 (m, 1H, NHCH), 2.43 (dtd, J=12.1 Hz, 7.5 Hz, 4.2 Hz, 1H, NHCH), 1.75 (dq, J=12.4 Hz, 7.9 Hz, 1H, NHCHCH₂), 1.56-1.16 (m, 12H, 6×CH₂), 0.8 (m, 6H, 2×CH₃).

¹³C NMR (101 MHz, Chloroform-d) δ_{C}/ppm 146.5, 143.4, 127.2, 126.3, 124.7, 124.0, 60.8, 55.8, 35.1, 34.7, 34.1, 30.3, 28.3, 27.8, 23.2, 23.0, 14.2(2C).

IR (vₘₐₓ/cm⁻¹, CHCl₃) 3022, 2955, 2858, 2389, 2285

MS (ESI) m/z calc. for C₁₈H₃₀N [M+H]⁺: 260.2373, found: 260.2371.

[α]²⁰₅₈₉=+28.0° (c 1.0, CHCl₃)

### (+)-(11bS)—N—((S)-2,3-dihydro-1H-inden-1-yl)-N-(nonan-5-yl)dinaphtho[2,1-d:1′,2′-f][1,3,2]dioxaphosphepin-4-amine (Ligand B)

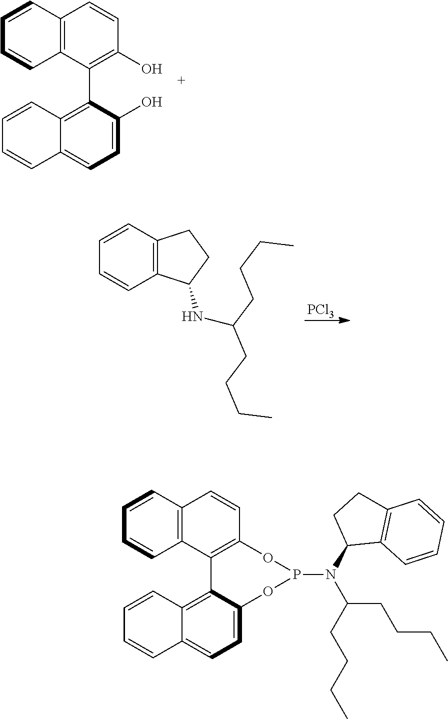

Triethylamine (8.46 mL, 5.0 eq., 63 mmol), was added dropwise to a stirred, ice-cooled solution of PCl₃ (1.13 mL, 1.0 eq., 12.6 mmol) in CH₂Cl₂ (60 ml). The ice bath was removed and the solution left to warm to room temperature before (S)—N-(nonan-5-yl)-2,3-dihydro-1H-inden-1-amine (3.28 g, 1.0 eq. 12.6 mmol) was added to the stirred solution in one portion. After 5 hours, (S)-binaphthol (3.16 g, 1.0 eq. 12.6 mmol.) was tipped into the suspension and the reaction mixture was left to stir for another 15 hours. The mixture was then filtered over an 2 cm pad of celite and silica gel, and CH₂Cl₂ (150 mL) was used to rinse the pad. The filtrate was concentrated to give a yellow residue and after flash column chromatography (petroleum ether: CH₂Cl₂: Et₃N, 80:20:1; SiO₂) the ligand was obtained as a white crystalline solid (2.35 g, 32%).

¹H NMR (500 MHz, CDCl₃) δ_{H}/ppm 7.95 (d, J=8.8 Hz, 1H, Ar—H), 7.90 (dd, J=8.4 Hz, 2.2 Hz, 3H, Ar—H), 7.72 (d, J=7.6 Hz, 1H, Ar—H), 7.61 (d, J=8.8 Hz, 1H, Ar—H), 7.49 (d, J=8.7 Hz, 1H, Ar—H), 7.44-7.37 (m, 3H, Ar—H), 7.34 (td, J=7.2 Hz, 6.7 Hz, 2.0 Hz, 1H, Ar—H), 7.28 (tt, J=3.9 Hz, 2.0 Hz, 2H, Ar—H), 7.27-7.19 (m, 3H, Ar—H), 4.76 (dt, J=15.4 Hz, 7.8 Hz, 1H, PhCHNH), 3.11-2.86 (m, 2H, PhCH₂), 2.75 (dt, J=16.1 Hz, 8.3 Hz, 1H, NHCH), 2.44 (d, J=11.3 Hz, 1H, PhCH₂CH₂), 2.26-2.00 (m, 1H, PhCH₂CH₂), 1.78 (tt, J=12.3 Hz, 4.4 Hz, 1H, CH₂), 1.72-1.61 (m, 1H, CH₂), 1.55-1.38 (m, 5H, CH₂), 1.39-0.97 (m, 5H, CH₂), 0.92 (t, J=7.3 Hz, 3H, CH₃), 0.87 (t, J=7.2 Hz, 3H, CH₃).

¹³C NMR (126 MHz, Chloroform-d) δ_{C}/ppm 150.2 (d, J=8.3 Hz), 149.9, 144.5, 143.3, 132.8, 131.3, 130.4, 130.2, 129.5, 128.2, 128.1, 127.4, 127.1, 127.1, 126.4, 125.9, 125.8, 125.2, 124.8, 124.60, 124.3, 124.0 (d, J=5.4 Hz), 122.3 (d, J=2.0 Hz)(2C), 122.3, 121.8 (d, J=2.4 Hz), 59.7 (d, J=21.3 Hz), 55.2 (d, J=4.3 Hz), 36.9 (d, J=5.4 Hz), 34.7, 31.6, 30.4, 29.3, 28.7, 23.1, 22.8, 14.2, 14.1.

³¹P NMR (162 MHz, Chloroform-d) δₚ/ppm 149.9.

IR (vₘₐₓ/cm⁻¹, CHCl₃) 2955, 2857, 1590, 1462, 1024, 947, 749, 697

MS (GCMS Ammonica Cl Spectrum) m/z calc. for C₃₈H₄₀O₂NP [M+H]⁺: 574.2875, found: 574.2876.

[α]²⁰₅₈₉=+126.3° (c 1.0, CHCl₃)

### Example 2—Synthesis of (+)-(11bS)—N-cycloheptyl-N—((S)-2,3-dihydro-1H-inden-1-yl)dinaphtho[2,1-d:1′,2′f][1,3,2]dioxaphosphepin-4-amine (Ligand E)

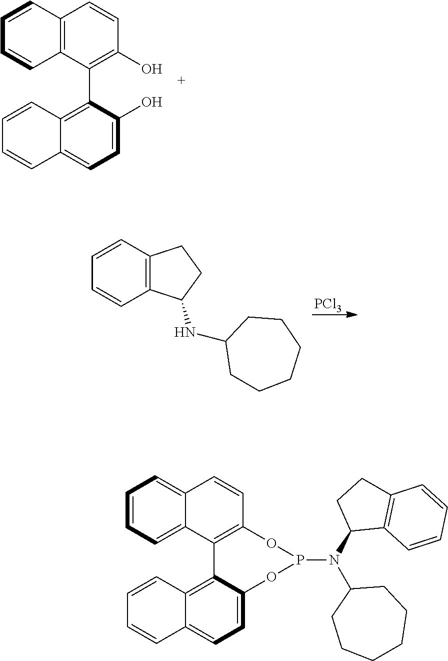

Triethylamine (0.8 mL, 5.0 eq., 6.0 mmol), was added dropwise to a stirred, ice-cooled solution of PCl₃ (0.11 mL, 1.0 eq., 1.2 mmol) in CH₂Cl₂. The ice bath was removed and the solution left to warm to room temperature before (S)—N-cyclohexyl-2, 3-dihydro-1H-inden-1-amine (0.28 g, 1.0 eq. 1.2 mmol) was added to the stirred solution in one portion. After 5 hours, (S)-binaphthol (0.33 g, 1.0 eq. 1.2 mmol) was tipped into the suspension and the reaction mixture was left to stir for another 15 hours. The mixture was then filtered over an 2 cm pad of celite and silica gel, and CH₂Cl₂ (30 mL) was used to rinse the pad. The filtrate was concentrated to give a yellow residue and after flash column chromatography (petroleum ether: CH₂Cl₂: Et₃N, 80:20:1; SiO₂) the ligand was obtained as a white crystalline solid (0.37 g, 57%).

¹H NMR (500 MHz, Chloroform-d) δ=7.96 (d, J=8.8 Hz, 1H, Ar—H), 7.91 (dd, J=8.2 Hz, 1.2 Hz, 1H, Ar—H), 7.87 (d, J=8.2 Hz, 1H, Ar—H), 7.85 (d, J=8.8 Hz, 1H, Ar—H), 7.64 (d, J=7.5 Hz, 1H, Ar—H), 7.56 (d, J=8.7 Hz, 1H, Ar—H), 7.51 (d, J=8.8, 1H, Ar—H), 7.45-7.36 (m, 3H, Ar—H), 7.35-7.30 (m, 2H, Ar—H), 7.30-7.17 (m, 4H, Ar—H), 4.76 (dt, J=13.3 Hz, 8.2 Hz, 1H, PhCHNH), 3.11-2.85 (m, 2H, PhCH₂), 2.68 (dt, J=15.8, 8.5, 1H, NHCH), 2.43 (d, J=9.9 Hz, 1H, PhCH₂CH₂), 2.23-2.05 (m, 2H, PhCH₂CH₂, CH₂), 2.06-1.88 (m, 2H, CH₂), 1.87-1.68 (m, 1H, CH₂), 1.68-1.52 (m, 2H, CH₂), 1.47-1.20 (m, 3H, CH₂), 1.18-0.80 (m, 3H, CH₂).

¹³C NMR (126 MHz, Chloroform-d) δ_{C}/ppm 150.3 (d, J=8.1 Hz), 150.1, 144.5, 143.1, 132.8 (d, J=1.7 Hz), 132.7, 131.3, 130.5, 130.2, 129.6, 128.3, 128.2, 127.2, 127.1, 126.4, 125.9, 125.8, 124.8, 124.6, 124.6, 124.3, 124.1 (d, J=5.3 Hz), 122.4, 122.4, 122.2, 121.7 (d, J=2.4 Hz), 60.7 (d, J=17.0 Hz), 56.6 (d, J=8.1 Hz), 38.4, 30.1, 27.3, 27.2, 25.2, 25.1, 22.7, 14.2.

³¹P NMR (162 MHz, CDCl₃) δ_{P}/ppm 151.2

IR (vₘₐₓ/cm⁻¹, CHCl₃) 2929, 2854, 2361, 1590, 1462, 1232, 1067, 947, 911, 798, 748.

MS (ESI) m/z calc. for C₃₆H₃₅O₂NP [M+H]+: 544.2399, found: 544.2394.

[α]²⁰₅₈₉=+122.2° (c=1.0, CHCl₃)

### Example 3—Synthesis of (+)-(11bS)—N-cyclooctyl-N—((S)-2,3-dihydro-1H-inden-1-yl)dinaphtho[2,1-d:1′,2′-f][1,3,2]dioxaphosphepin-4-amine (Ligand F)

### (+)-(S)—N-cyclooctyl-2,3-dihydro-1H-inden-1-amine

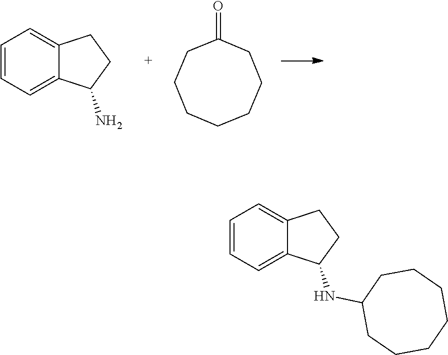 [SMILES: N[C@H]1CCc2ccccc21 ; O=C1CCCCCCC1 ; c1ccc2c(c1)CC[C@@H]2NC1CCCCCCC1]

According to a modified procedure from Davies and co-workers,²⁵ cyclooctanone (1.47 g, 1.5 eq. 11.6 mmol) was added to a stirring solution of (S)-(+)-1-Aminoindane (1.00 mL, 1.0 eq. 7.76 mmol.) in THF at room temperature. After 5 minutes, Na(OAc)₃H (2.50 g, 1.5 eq., 11.6 mmol) was tipped into the mixture. The reaction was kept under room temperature for 48 hours, and the resulting suspension was added to a 1:1 mixture of Et₂O and NaHCO₃ (aq. sat.) and stirred for another half an hour. The mixture was partitioned between the aqueous and Et₂O layers and the aqueous phase extracted with Et₂O three times. The combined organic phase was concentrated in vacuo. Then HCl (aq.2 M) was added dropwise (25 ml. pH=1). The mixture was partitioned between the aqueous and organic phases, and the organic phase was extracted with HCl (aq. 2.0 M). Then CH₂Cl₂ was added to the combined aqueous phases and NaOH (4 M) was added till the mixture became basic (pH>14). The mixture was partitioned between aqueous and organic phases. CH₂Cl₂ was used to extract residual product from the aqueous layer (three extracts). The combined organic layers were concentrated, dried (MgSO₄), filtered and concentrated to give the, desired product, (1.692 g, 90%) as dark oil

¹H NMR (400 MHz, Chloroform-d) δ_{H}/ppm 7.4-7.3 (m, 1H, Ar—H), 7.2 (m, 3H, Ar—H), 4.3 (t, J=6.8 Hz, 1H, PhCHNH), 3.1-2.9 (m, 2H, PhCH₂), 2.8 (dt, J=15.8 Hz, 7.9 Hz, 1H, NHCH), 2.4 (dddd, J=12.5 Hz, 8.1 Hz, 6.9 Hz, 4.3 Hz, 1H, PhCH₂CH₂), 2.0-1.8 (m, 1H, PhCH₂CH₂), 1.8-1.7 (m, 5H, CH₂), 1.7-1.4 (m, 7H, CH₂), 1.3-1.0 (m, 2H, CH₂).

¹³C NMR (101 MHz, Chloroform-d) δ_{C}/ppm 146.4, 143.4, 127.2, 126.3, 124.7, 123.9, 60.5, 55.7, 34.8, 33.9, 32.2, 30.3, 27.5, 27.4, 25.8, 24.2, 24.1.

IR (vₘₐₓ/cm₋₁, CHCl₃) 3021, 2919, 2849, 1474, 1258

MS (ESI) m/z calc. for C₁₇H₂₆N [M+H]⁺: 244.2060, found: 244.2058.

[α]²⁰₅₈₉=+37.6° (c 2.0, CHCl₃).

### (+)-(11bS)—N-cyclooctyl-N—((S)-2,3-dihydro-1H-inden-1-yl)dinaphtho[2,1-d:1′,2′-f][1,3,2]dioxaphosphepin-4-amine (Ligand F)

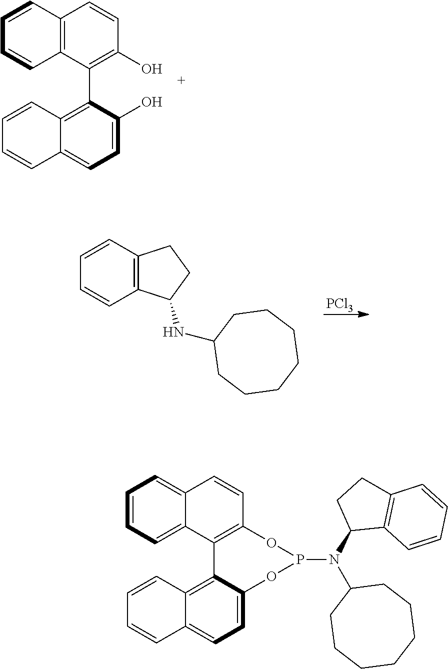

Triethylamine (2.92 mL, 5.0 eq., 20.5 mmol), was added dropwise to a stirred, ice-cooled solution of PCl₃ (0.38 mL, 1.0 eq., 4.1 mmol) in CH₂Cl₂. The ice bath was removed and the solution left to warm to room temperature before (S)—N-cyclohexyl-2, 3-dihydro-1H-inden-1-amine (0.94 ml, 1.0 eq. 4.1 mmol) was added to the stirred solution in one portion. After 5 hours, (S)-binaphthol (1.12 g, 1.0 eq. 4.1 mmol) was tipped into the suspension and the reaction mixture was left to stir for another 15 hours. The mixture was then filtered over an ˜2 cm pad of celite and silica gel, and CH₂Cl₂ (100 mL) was used to rinse the pad. The filtrate was concentrated to give a yellow residue and after flash column chromatography (petroleum ether: CH₂Cl₂: Et₃N, 80:20:1; SiO₂) the ligand was obtained as a white crystalline solid (1.17 g, 51%).

¹H NMR (500 MHz, Chloroform-d) δ_{H}/ppm 7.97 (d, J=8.8 Hz, 1H, Ar—H), 7.92 (dd, J=8.3 Hz, 1.2 Hz, 1H, Ar—H), 7.90-7.83 (m, 2H, Ar—H), 7.64 (d, J=7.6 Hz, 1H, Ar—H), 7.61 (s, 1H, Ar—H), 7.52 (d, J=8.7 Hz, 1H, Ar—H), 7.44-7.37 (m, 3H, Ar—H), 7.37-7.29 (m, 2H, Ar—H), 7.30-7.18 (m, 4H, Ar—H), 4.76 (dt, J=13.4 Hz, 8.1 Hz, 1H, PhCHNH), 3.11 (d, J=10.6 Hz, 1H, PhCH₂CH₂), 3.02-2.90 (m, 1H, PhCH₂CH₂), 2.70 (p, J=8.3 Hz, 1H, NHCH), 2.44 (d, J=11.4 Hz, 1H, PhCH₂CH₂), 2.16 (p, J=9.9 Hz, 1H, PhCH₂CH₂), 2.09-1.79 (m, 3H, CH₂), 1.72-1.57 (m, 2H, CH₂), 1.43-1.05 (m, 8H, CH₂), 0.99-0.75 (m, 1H, CH₂).

¹³C NMR (126 MHz, Chloroform-d) δ_{C}/ppm 150.2 (d, J=8.0 Hz), 150.1, 144.6, 143.14, 132.8 (d, J=2.2 Hz), 132.8, 131.3, 130.6, 130.2, 129.7, 128.3, 128.1, 127.3, 127.1, 127.1, 126.4, 125.9, 125.9, 124.7 (d, J=5.1 Hz), 124.6, 124.3, 124.0 (d, J=5.3 Hz), 122.4, 122.4, 122.3, 121.7 (d, J=2.4 Hz), 60.7 (d, J=16.3 Hz), 54.8 (d, J=7.7 Hz), 36.5 (d, J=131.2), 31.6, 30.2, 26.3, 25.8, 25.6, 24.5, 22.7, 14.2.

³¹P NMR (162 MHz, CDCl₃) δ_{P}/ppm 151.7.

IR (vₘₐₓ/cm⁻¹, CHCl₃) 2929, 2854, 2361, 1590, 1462

MS (GCMS Ammonica Cl Spectrum) m/z calc. for C₃₇H₃₆O₂NP [M+H]⁺: 557.2484, found: 558.2558.

[α]²⁰₅₈₉=+117.1° (c 1.0, CHCl₃)

### Example 4

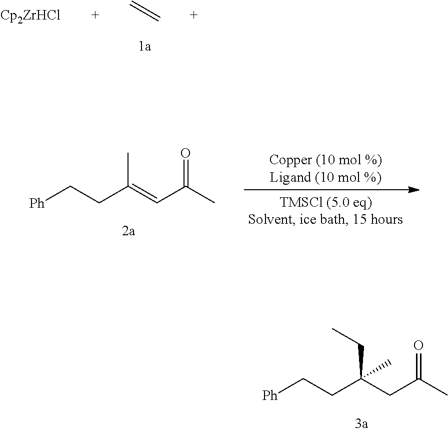

The hydrometallation-ACA of ethylene (1a) and (E)-4-methyl-6-phenylhex-3-en-2-one (2a) was investigated under reactions conditions previously applied in the formation of cyclic quaternary centres¹⁵ and acyclic tertiary stereocenters¹⁷.

TABLE 1

| Entry | Copper source | Solvent | Ligand | Yield % | ee %* |
|---|---|---|---|---|---|
| 1 (REF) | CuCl + AgNTf₂ | t-BuOMe | A | 46 | 45 |
| 2 (REF) | CuCl + AgOTf | Et₂O | C | 70 | 77 |
| 3 | CuCl + AgOTf | Et₂O | B | 80 | 91 |
| 4 | CuCl + AgOTf | Et₂O | E | 80 | 86 |
| 5 | CuCl + AgOTf | Et₂O | F | 78 | 86 |

*determined by HPLC

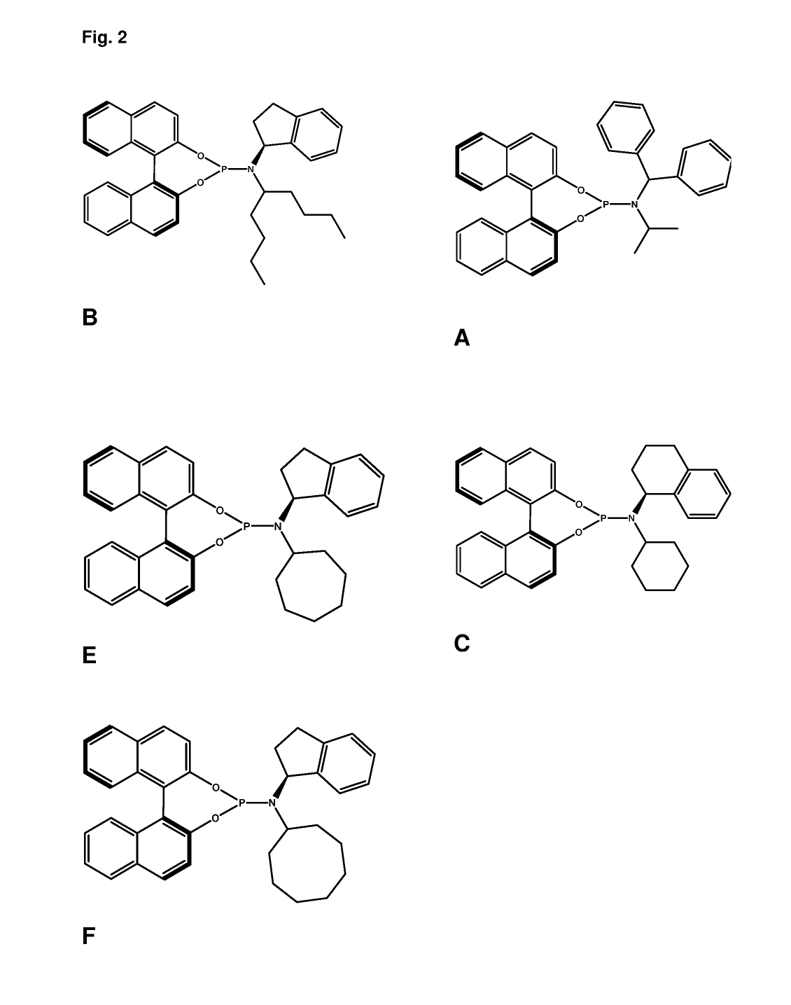

Reaction using ligand A (see FIG. 2) gave 3a with 46% yield, 45% ee using conditions optimized for cyclic quaternary centres (Table 1, entry 1), and ligand C (see FIG. 2) gave 70% yield, 77% ee using conditions developed for acyclic tertiary centres (Table 1, entry 2).

Ligands E, F and B (see FIG. 2) of the present invention were prepared and tested. These new ligands have different branched aliphatic groups attached at the amine portion of the phosphoramidite. All of these new ligands performed better (Table 1, entries 3, 4 and 5) than known ligands A and C.

Ligand B, bearing two alkyl chains, gave the best enantioselectivity and is capable of giving acyclic, all-carbon quaternary centres with 80% isolated yield and >90% ee (Table 1, entry 3).

### Example 5

The scope of the enone reactant tolerated in this reaction was explored using Ligand B.

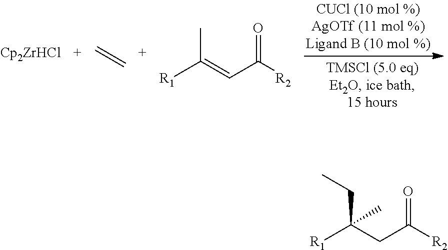

TABLE 2

| Entry | Substrate | Product | Yield %** | ee %* |
|---|---|---|---|---|
| 1 | 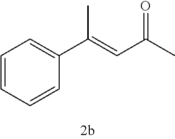 | 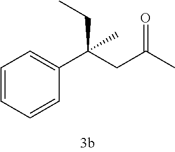 | 50 | 90 |
| 2 | 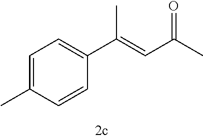 | 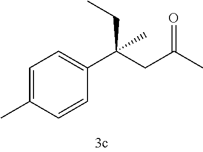 | 34 | 89 |
| 3 | 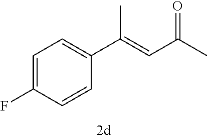 | 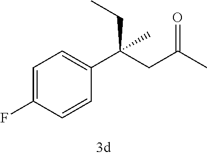 | 46 | 91 |
| 4 | 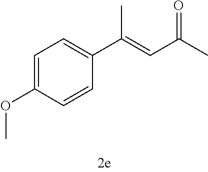 | 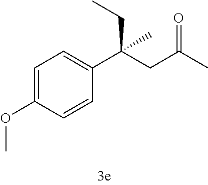 [SMILES: CC[C@@](C)(CC(C)=O)c1ccc(OC)cc1] | 39 | 73 |
| 5 | 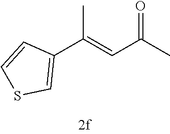 | 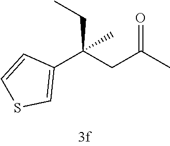 | 41 | 85 |
| 6 | 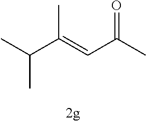 | 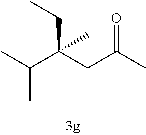 | 48 | 92 |
| 7 | 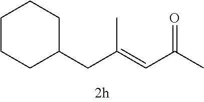 | 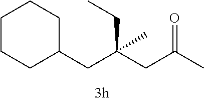 | 71 | 98 |
| 8 | 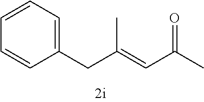 | 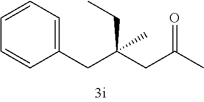 | 61 | 93 |
| 9 | 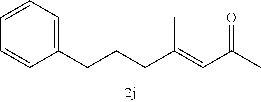 | 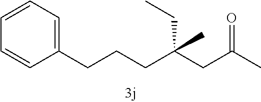 [SMILES: CC[C@@](C)(CCCc1ccccc1)CC(C)=O] | 80 | 93 |
| 10 | 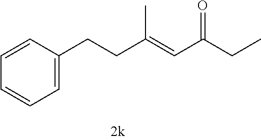 | 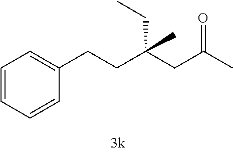 [SMILES: CC[C@@](C)(CCc1ccccc1)CC(C)=O] | 80 | 96 |
| 11 | 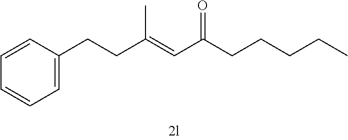 [SMILES: CCCCCC(=O)/C=C(\C)CCc1ccccc1] | 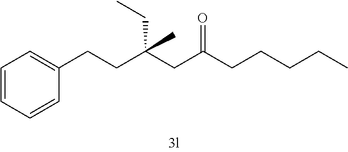 [SMILES: CCCCCC(=O)C[C@@](C)(CC)CCc1ccccc1] | 54 | 96 |

*determined by HPLC; **isolated yield

As is evident from Table 2, the reaction was found to tolerate a variety of enone electrophiles resulting in generally high ee's.

### Example 6

The scope of the alkene reactant tolerated in this reaction was explored using Ligand B.

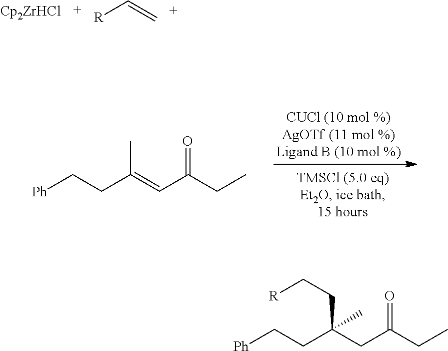

TABLE 3

| Entry | Substrate | Product | Yield %** | ee %* |
|---|---|---|---|---|
| 1 | 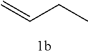 | 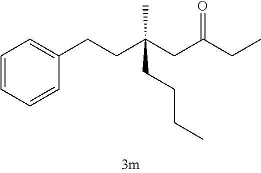 | 53 | 93 |
| 2 | 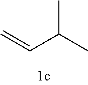 | 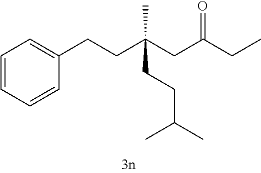 | 70 | 90 |
| 3 | 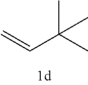 | 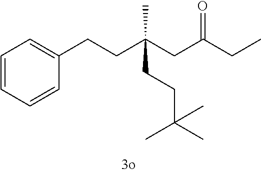 | 69 | 85 |
| 4 | 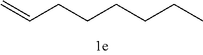 | 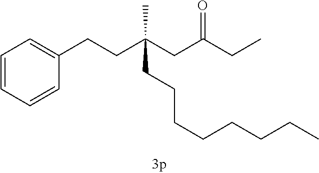 | 56 | 92 |
| 5 | 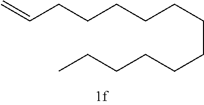 | 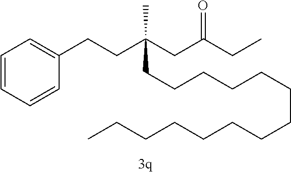 | 59 | 90 |
| 6 | 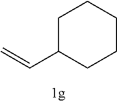 | 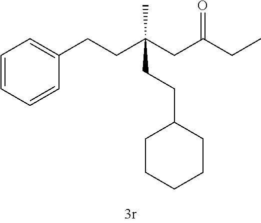 | 64 | 90 |
| 7 | 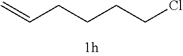 | 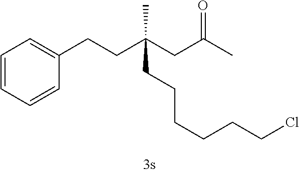 | 51 | 84 |
| 8 | 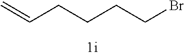 | 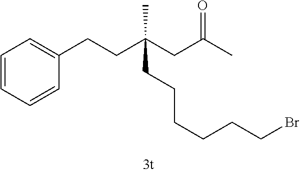 | 46 | 87 |
| 9 | 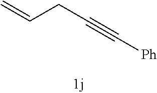 | 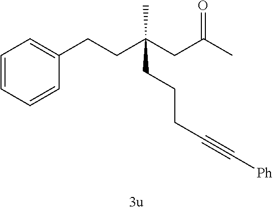 | 52 | 78 |
| 10 | 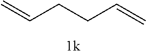 | 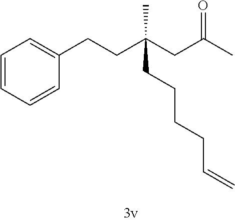 | 55 | 74 |
| 11 | 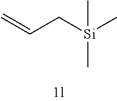 | 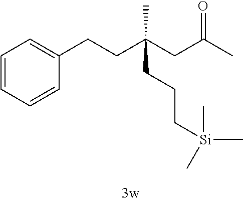 | 42 | 88 |
| 12 | 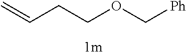 | 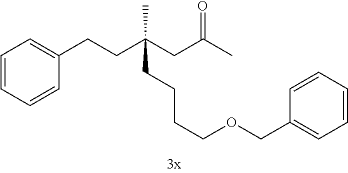 | 54 | 82 |
| 13 | 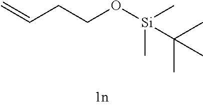 | 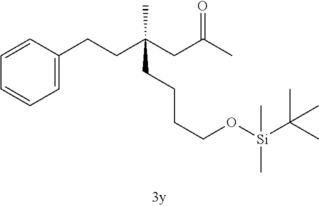 | 71 | 91 |
| 14 | 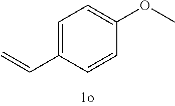 | 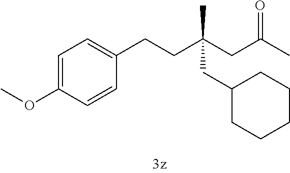 | 24 | 88 |
| 15 | 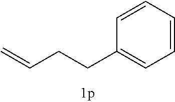 | 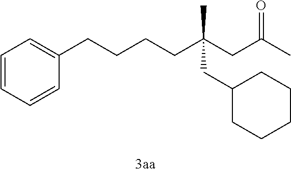 | 35 | 92 |

*determined by HPLC; **isolated yield

As is evident from Table 3, the reaction was found to tolerate a variety of alkenes comprising a range of functional groups. Enanantioselectivity was uniformly high.

### Example 7—Synthesis of (+)-(R)-4-Ethyl-4-methyl-6-phenylhexan-2-one (2a)

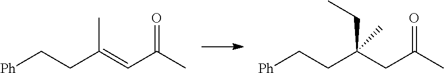 [SMILES: CC(=O)/C=C(\C)CCc1ccccc1 ; CC[C@](C)(CCc1ccccc1)CC(C)=O]

CuCl (1.9 mg, 0.02 mmol, 0.1 eq.), and the phosphoramidite ligand B (11.5 mg, 0.02 mmol, 0.1 eq.) were added to a flame dried round bottom flask containing Et₂O (1 mL) under an argon atmosphere. The resulting mixture was stirred at room temperature for 1 hour and then AgOTf (5.6 mg, 0.022 mmol, 0.11 eq.) was added and the mixture was stirred for an additional 15 min.

To a second, flame dried, round bottom flask, Cp₂ZrHCl (103 mg, 0.4 mmol, 2.0 eq.) was added. A balloon filled with ethylene was used to purge the flask with ethylene for 5 min, and then CH₂Cl₂ (0.2 mL) was added. After stirring for 15 min under an ethylene atmosphere (balloon), a clear yellow solution was obtained. After stirring for 15 min, the stirred solution containing the copper and ligand was transferred, and filltered—using a syringe filter—to the solution containing the zirconocene species.

The resulting black mixture was stirred for another 10 min before enone 2a (38.0 mg, 0.2 mmol, 1.0 eq.) and then TMSCl (0.127 mL, 1.0 mmol, 5.0 eq.) were each added dropwise. Stirring was continued for 15 h at 0° C., before the reaction was quenched by the addition of 1.5 mL NH4Cl and then 3.0 mL Et₂O. The mixture was partitioned between the aqueous and organic phases, and the aqueous layer was extracted with Et₂O (3×10 mL).

The combined organic materials were dried with Na₂SO₄, filtered, concentrated, and the resulting yellow residue purified by flash column chromatography (petrol: Et₂O; 90:10; SiO₂) to give the desired product.

(+)-(R)-4-Ethyl-4-methyl-6-phenylhexan-2-one (35 mg, 80% yield, 91% ee) HPLC analysis indicated an enantiomeric excess of 91% [two Chiralpak® ID in series; flow: 0.8 mL min-1; hexane/iPrOH: 99:1; λ=210 nm; major enantiomer tR=14.58 min; minor enantiomer, tR=15.65 min].

### Example 8—Synthesis of (+)-(R)-4-ethyl-4-methyl-6-phenylhexan-2-one (3a)

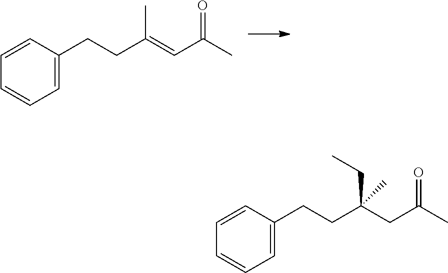 [SMILES: CC(=O)/C=C(\C)CCc1ccccc1 ; CC[C@](C)(CCc1ccccc1)CC(C)=O]

CuCl (1.9 mg, 0.02 mmol, 0.1 eq.), and the phosphoramidite ligand B (11.5 mg, 0.02 mmol, 0.1 eq.) were added to a flame dried round bottom flask containing 1 mL Et₂O under argon and the resulting mixture was stirred at room temperature. After 1 hour, AgOTf (5.6 mg, 0.022 mmol, 0.11 eq.) was added and the mixture was stirred for an additional 15 min. To a second, flame dried, round bottom flask, Cp₂ZrHCl (103 mg, 0.4 mmol, 2.0 eq.) was added. A balloon filled with ethylene was used to purge the flask with ethylene for 5 min, and then CH₂Cl₂ (0.2 mL) was added. After stirring for 15 min under an ethylene atmosphere (balloon), a clear yellow solution was obtained. After stirring for 15 min, the stirred solution containing the copper and ligand was transferred, and filtered—using a syringe filter, to the solution containing the zirconocene species. The resulting black mixture was stirred for another 10 min before the enone (38.0 mg, 0.2 mmol, 1.0 eq.) and then TMSCl (0.127 ml, 1.0 mmol, 5.0 eq.) were each added dropwise. Stirring was continued for 15 h at 0° C., before the reaction was quenched by the addition of 1.5 mL NH₄Cl and then 3.0 mL Et₂O. The mixture was partitioned between the aqueous and organic phases, and the aqueous layer was extracted with Et₂O (3×10 mL). The combined organic materials were dried with Na₂SO₄, filtered, concentrated, and the resulting yellow residual purified by flash column chromatography (Petrol: Et₂O; 90:10; SiO₂) to give the desired product. (35 mg, 80% yield, 91% ee).

HPLC analysis indicated an enantiomeric excess of 91% [two Chiralpak® ID in series; flow: 0.8 mL/min; hexane/i-PrOH: 99:1; λ=210 nm; major enantiomer tR=14.58 min; minor enantiomer, tR=15.65 min].

¹H NMR (400 MHz, CDCl₃) δ_{H}/ppm 7.23-7.16 (m, 2H, Ar—H), 7.14-7.06 (m, 3H, Ar—H), 2.51-2.39 (m, 2H, PhCH₂), 2.32 (s, 2H, CH₂COCH₃), 2.07 (s, 3H, COCH₃), 1.62-1.50 (m, 2H, PhCH₂CH₂), 1.38 (q, 2H, CH₂CH₃), 0.96 (s, 3H, CH₃), 0.79 (t, J=7.5 Hz, 3H, CH₂CH₃).

¹³C NMR (101 MHz, Chloroform-d) δ_{C}/ppm 208.9, 143.0, 128.4 (4C), 125.7, 51.2, 41.1, 36.3, 32.7, 31.7, 30.4, 24.6, 8.1.

IR (vₘₐₓ/cm⁻¹, CHCl₃) 3063, 2879, 1714, 1603, 1496, 1153, 699.

MS (ESI) m/z calc. for C₁₅H₂₂O²³Na [M+Na]⁺: 241.1563, found: 241.1563.

[α]²⁰₅₈₉=+4.1° (c 1.0, CHCl₃).

### Example 9—Synthesis of (+)-(S)-4-methyl-4-phenylhexan-2-one (3b)

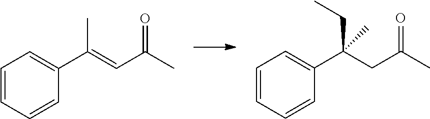

CuCl (1.9 mg, 0.02 mmol, 0.1 eq.), and the phosphoramidite ligand B (11.5 mg, 0.02 mmol, 0.1 eq.) were added to a flame dried round bottom flask containing 1 mL Et₂O under argon and the resulting mixture was stirred at room temperature. After 1 hour, AgOTf (5.6 mg, 0.022 mmol, 0.11 eq.) was added and the mixture was stirred for an additional 15 min. To a second, flame dried, round bottom flask, Cp₂ZrHCl (103 mg, 0.4 mmol, 2.0 eq.) was added. A balloon filled with ethylene was used to purge the flask with ethylene for 5 min, and then CH₂Cl₂ (0.2 mL) was added. After stirring for 15 min under an ethylene atmosphere (balloon), a clear yellow solution was obtained. After stirring for 15 min, the stirred solution containing the copper and ligand was transferred, and filtered—using a syringe filter, to the solution containing the zirconocene species. The resulting black mixture was stirred for another 10 min before the enone (32.0 mg, 0.2 mmol, 1.0 eq.) and then TMSCl (0.127 ml, 1.0 mmol, 5.0 eq.) were each added dropwise. Stirring was continued for 15 h at 0° C., before the reaction was quenched by the addition of 1.5 mL NH₄Cl and then 3.0 mL Et₂O. The mixture was partitioned between the aqueous and organic phases, and the aqueous layer was extracted with Et₂O (3×10 mL). The combined organic materials were dried with Na₂SO₄, filtered, concentrated, and the resulting yellow residual purified by flash column chromatography (Petrol: Et₂O; 90:10; SiO₂) to give the desired product. (19 mg, 50% yield, 90% ee).

HPLC analysis indicated an enantiomeric excess of 91% [Chiralpak® IB; flow: 0.8 mL/min; hexane/i-PrOH: 99:1; λ=210 nm; major enantiomer tR=7.33 min; minor enantiomer, tR=7.68 min].

¹H NMR (400 MHz, Chloroform-d) δ_{H}/ppm 7.50-7.21 (m, 4H, Ar—H), 7.23-7.02 (m, 1H, Ar—H), 2.83 (d, J=14.1 Hz, 1H, CH₂CO), 2.54 (d, J=14.2 Hz, 1H, CH₂CO), 1.80 (dt, J=14.8 Hz, 7.3 Hz, 1H, CH₂CH₃), 1.71 (s, 3H, COCH₃), 1.69-1.55 (m, 1H, CH₂CH₃), 1.36 (s, 3H, CH₃), 0.63 (t, J=7.4 Hz, 3H, CH₂CH₃).

¹³C NMR (101 MHz, Chloroform-d) δ_{C}/ppm 208.3, 146.3, 128.5, 128.2 (2C), 126.2 (2C), 125.9, 56.1, 40.7, 35.5, 32.0, 23.2, 8.5.

IR (vₘₐₓ/cm⁻¹, CHCl₃) 3025, 2855, 1703, 1357, 760, 662.

MS (ESI) m/z=[M+Na]⁺: 213.2(100).

[α]²⁰₅₈₉=+44.7° (c 0.8, CHCl₃).

### Example 10—Synthesis of (+)-(S)-4-methyl-4-(p-tolyl)hexan-2-one (3c)

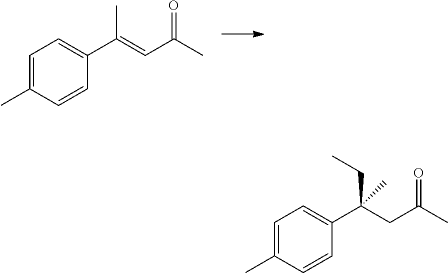

CuCl (1.9 mg, 0.02 mmol, 0.1 eq.), and the phosphoramidite ligand B (11.5 mg, 0.02 mmol, 0.1 eq.) were added to a flame dried round bottom flask containing 1 mL Et₂O under argon and the resulting mixture was stirred at room temperature. After 1 hour, AgOTf (5.6 mg, 0.022 mmol, 0.11 eq.) was added and the mixture was stirred for an additional 15 min. To a second, flame dried, round bottom flask, Cp₂ZrHCl (103 mg, 0.4 mmol, 2.0 eq.) was added. A balloon filled with ethylene was used to purge the flask with ethylene for 5 min, and then CH₂Cl₂ (0.2 mL) was added. After stirring for 15 min under an ethylene atmosphere (balloon), a clear yellow solution was obtained. After stirring for 15 min, the stirred solution containing the copper and ligand was transferred, and filtered—using a syringe filter, to the solution containing the zirconocene species. The resulting black mixture was stirred for another 10 min before the enone (35.0 mg, 0.2 mmol, 1.0 eq.) and then TMSCl (0.127 ml, 1.0 mmol, 5.0 eq.) were each added dropwise. Stirring was continued for 15 h at 0° C., before the reaction was quenched by the addition of 1.5 mL NH₄Cl and then 3.0 mL Et₂O. The mixture was partitioned between the aqueous and organic phases, and the aqueous layer was extracted with Et₂O (3×10 mL). The combined organic materials were dried with Na₂SO₄, filtered, concentrated, and the resulting yellow residual purified by flash column chromatography (Petrol: Et₂O; 90:10; SiO₂) to give the desired product. (20 mg, 34% yield, 89% ee).

HPLC analysis indicated an enantiomeric excess of 89% [Chiralpak® IC; flow: 1.0 mL/min; hexane/i-PrOH: 99:1; λ=210 nm; major enantiomer tR=9.76 min; minor enantiomer, tR=10.28 min].

¹H NMR (400 MHz, Chloroform-d) δ_{H}/ppm 7.23-7.17 (m, 2H, Ar—H), 7.16-7.09 (m, 2H, Ar—H), 2.86 (d, J=14.1 Hz, 1H, CH₂CO), 2.63-2.5 (m, 1H, CH₂CO), 2.32 (s, 3H, Ar—CH₃), 1.85 (dt, J=13.7 Hz, 7.4 Hz, 1H, CH₂CH₃), 1.77 (s, 3H, COCH₃), 1.72-1.53 (m, 1H, CH₂CH₃), 1.39 (s, 3H, CH₃), 0.68 (t, J=7.4 Hz, 3H, CH₂CH₃).

¹³C NMR (101 MHz, Chloroform-d) δ_{C}/ppm 208.5, 143.2, 135.3, 129.0(2C), 126.1(2C), 56.1, 40.4, 35.5, 32.1, 23.3, 20.9, 8.5.

IR (vₘₐₓ/cm⁻¹, CHCl₃) 3658, 2980, 2886, 1704, 1381, 1153, 955, 815.

MS (ESI) m/z calc. for C₁₄H₂₀O²³Na [M+Na]⁺: 227.1406, found: 227.1406.

[α]²⁰₅₈₉=+41.0° (c 1.0, CHCl₃).

### Example 11—Synthesis of (+)-(S)-4-(4-fluorophenyl)-4-methylhexan-2-one (3d)

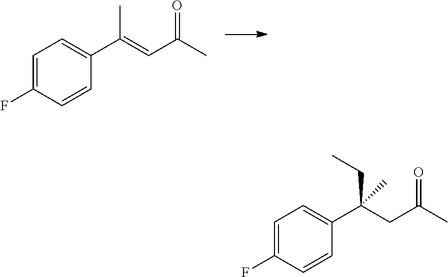

CuCl (1.9 mg, 0.02 mmol, 0.1 eq.), and the phosphoramidite ligand B (11.5 mg, 0.02 mmol, 0.1 eq.) were added to a flame dried round bottom flask containing 1 mL Et₂O under argon and the resulting mixture was stirred at room temperature. After 1 hour, AgOTf (5.6 mg, 0.022 mmol, 0.11 eq.) was added and the mixture was stirred for an additional 15 min. To a second, flame dried, round bottom flask, Cp₂ZrHCl (103 mg, 0.4 mmol, 2.0 eq.) was added. A balloon filled with ethylene was used to purge the flask with ethylene for 5 min, and then CH₂Cl₂ (0.2 mL) was added. After stirring for 15 min under an ethylene atmosphere (balloon), a clear yellow solution was obtained. After stirring for 15 min, the stirred solution containing the copper and ligand was transferred, and filtered—using a syringe filter, to the solution containing the zirconocene species. The resulting black mixture was stirred for another 10 min before the enone (36.0 mg, 0.2 mmol, 1.0 eq.) and then TMSCl (0.127 ml, 1.0 mmol, 5.0 eq.) were each added dropwise. Stirring was continued for 15 h at 0° C., before the reaction was quenched by the addition of 1.5 mL NH₄Cl and then 3.0 mL Et₂O. The mixture was partitioned between the aqueous and organic phases, and the aqueous layer was extracted with Et₂O (3×10 mL). The combined organic materials were dried with Na₂SO₄, filtered, concentrated, and the resulting yellow residual purified by flash column chromatography (Petrol: Et₂O; 90:10; SiO₂) to give the desired product. (23 mg, 46% yield, 91% ee).

HPLC analysis indicated an enantiomeric excess of 91% [two Chiralpak® IC in series; flow: 1.0 mL/min; hexane/i-PrOH: 99:1; λ=210 nm; major enantiomer tR=17.95 min; minor enantiomer, tR=18.48 min].

¹H NMR (400 MHz, Chloroform-d) δ_{H}/ppm 7.31-7.16 (m, 2H, Ar—H), 7.04-6.91 (m, 2H, Ar—H), 2.83 (d, J=14.6 Hz, 1H, CH₂CO), 2.64-2.51 (m, 1H, CH₂CO), 1.85-1.71 (m, 4H, COCH₃, CH₂CH₃), 1.63 (dq, J=13.7 Hz, 7.4 Hz, 1H, CH₂CH₃), 1.37 (s, 3H, CH₃), 0.64 (t, J=7.4 Hz, 3H, CH₂CH₃).

¹³C NMR (101 MHz, Chloroform-d) δ_{C}/ppm 207.9, 161.0, 142.0, 127.7 (2C), 114.9 (2C), 56.0, 40.3, 35.7, 32.0, 23.4, 8.4.

IR (vₘₐₓ/cm⁻¹, CHCl₃) 3659, 2981, 2885, 1510, 1381, 1165, 956, 741.

MS (ESI) m/z [M+Na]⁺: 231.1.

[α]²⁰₅₈₉=+30.0° (c 1.0, CHCl₃).

### Example 12—Synthesis of (+)-(S)-4-(4-methoxyphenyl)-4-methylhexan-2-one (3e)

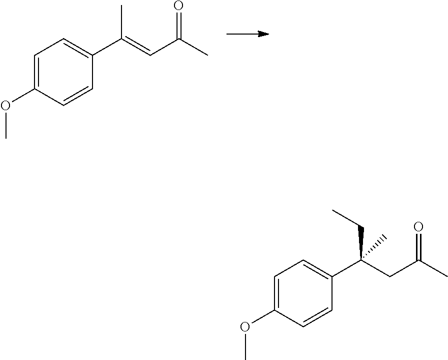 [SMILES: COc1ccc(/C(C)=C/C(C)=O)cc1 ; CC[C@@](C)(CC(C)=O)c1ccc(OC)cc1]

CuCl (1.9 mg, 0.02 mmol, 0.1 eq.), and the phosphoramidite ligand B (11.5 mg, 0.02 mmol, 0.1 eq.) were added to a flame dried round bottom flask containing 1 mL Et₂O under argon and the resulting mixture was stirred at room temperature. After 1 hour, AgOTf (5.6 mg, 0.022 mmol, 0.11 eq.) was added and the mixture was stirred for an additional 15 min. To a second, flame dried, round bottom flask, Cp₂ZrHCl (103 mg, 0.4 mmol, 2.0 eq.) was added. A balloon filled with ethylene was used to purge the flask with ethylene for 5 min, and then CH₂Cl₂ (0.2 mL) was added. After stirring for 15 min under an ethylene atmosphere (balloon), a clear yellow solution was obtained. After stirring for 15 min, the stirred solution containing the copper and ligand was transferred, and filtered—using a syringe filter, to the solution containing the zirconocene species. The resulting black mixture was stirred for another 10 min before the enone (38.0 mg, 0.2 mmol, 1.0 eq.) and then TMSCl (0.127 ml, 1.0 mmol, 5.0 eq.) were each added dropwise. Stirring was continued for 15 h at 0° C., before the reaction was quenched by the addition of 1.5 mL NH₄Cl and then 3.0 mL Et₂O. The mixture was partitioned between the aqueous and organic phases, and the aqueous layer was extracted with Et₂O (3×10 mL). The combined organic materials were dried with Na₂SO₄, filtered, concentrated, and the resulting yellow residual purified by flash column chromatography (Petrol: Et₂O; 90:10; SiO₂) to give the desired product. (15 mg, 39% yield, 73% ee).

HPLC analysis indicated an enantiomeric excess of 73% [Chiralpak® ID; flow: 1.0 mL/min; hexane/i-PrOH: 95:5; λ=225 nm; major enantiomer tR=7.91 min; minor enantiomer, tR=8.84 min].

¹H NMR (400 MHz, Chloroform-d) δ_{H}/ppm 7.30-7.02 (m, 2H, Ar—H), 6.91-6.60 (m, 2H, Ar—H), 3.73 (s, 3H, OCH₃), 2.77 (d, J=14.0 Hz, 1H, CH₂CO), 2.49 (d, J=14.0 Hz, 1H, CH₂CO), 1.76 (dq, J=14.7 Hz, 7.5 Hz, 1H, CH₂CH₃), 1.69 (s, 3H, COCH₃), 1.64-1.47 (m, 1H, CH₂CH₃), 1.31 (s, 3H, CH₃), 0.61 (t, J=7.4 Hz, 3H, CH₂CH₃).

¹³C NMR (101 MHz, Chloroform-d) δ_{C}/ppm 208.6, 157.6, 138.2, 127.2(2C), 113.5(2C), 56.3, 55.2, 40.2 35.6, 32.1, 23.3, 8.4.

IR (vₘₐₓ/cm⁻¹, CHCl₃) 3659, 2981, 2888, 1514, 1382, 1153, 955, 829.

MS (ESI) m/z [M+Na]⁺: 243.1(100).

[α]²⁰₅₈₉=+35.5° (c 1.0, CHCl₃).

### Example 13—Synthesis of (+)-(S)-4-methyl-4-(thiophen-3-yl)hexan-2-one (3f)

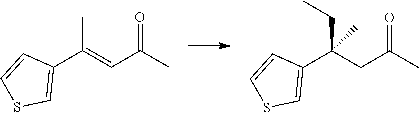

CuCl (1.9 mg, 0.02 mmol, 0.1 eq.), and the phosphoramidite ligand B (11.5 mg, 0.02 mmol, 0.1 eq.) were added to a flame dried round bottom flask containing 1 mL Et₂O under argon and the resulting mixture was stirred at room temperature. After 1 hour, AgOTf (5.6 mg, 0.022 mmol, 0.11 eq.) was added and the mixture was stirred for an additional 15 min. To a second, flame dried, round bottom flask, Cp₂ZrHCl (103 mg, 0.4 mmol, 2.0 eq.) was added. A balloon filled with ethylene was used to purge the flask with ethylene for 5 min, and then CH₂Cl₂ (0.2 mL) was added. After stirring for 15 min under an ethylene atmosphere (balloon), a clear yellow solution was obtained. After stirring for 15 min, the stirred solution containing the copper and ligand was transferred, and filtered—using a syringe filter, to the solution containing the zirconocene species. The resulting black mixture was stirred for another 10 min before the enone (34.0 mg, 0.2 mmol, 1.0 eq.) and then TMSCl (0.127 ml, 1.0 mmol, 5.0 eq.) were each added dropwise. Stirring was continued for 15 h at 0° C., before the reaction was quenched by the addition of 1.5 mL NH₄Cl and then 3.0 mL Et₂O. The mixture was partitioned between the aqueous and organic phases, and the aqueous layer was extracted with Et₂O (3×10 mL). The combined organic materials were dried with Na₂SO₄, filtered, concentrated, and the resulting yellow residual purified by flash column chromatography (Petrol: Et₂O; 90:10; SiO₂) to give the desired product. (16 mg, 41% yield, 85% ee).

HPLC analysis indicated an enantiomeric excess of 85% [Chiralpak® IB; flow: 1.0 mL/min; hexane/i-PrOH: 99:1; λ=210 nm; major enantiomer tR=6.65 min; minor enantiomer, tR=7.15 min].

¹H NMR (Chloroform-d, 400 MHz) δ_{H}/ppm 7.26-7.08 (1H, m, Ar—H), 6.92 (1H, dd, J=5.0 Hz, 1.4 Hz, Ar—H), 6.83 (1H, dd, J=2.9 Hz, 1.4 Hz, Ar—H), 2.66 (1H, d, J=13.6 Hz, CH₂CO), 2.45 (1H, d, J=13.7 Hz, CH₂CO), 1.67 (3H, s, CO CH₃), 1.65-1.39 (2H, m, CH₂), 1.26 (3H, s, CH₃), 0.60 (3H, t, J=7.4 Hz, CH₂CH₃).

¹³C NMR (Chloroform-d, 101 MHz) δ_{C}/ppm 208.2, 148.3, 126.0, 125.4, 119.7, 55.3, 39.4, 35.0, 31.7, 23.8, 8.4

IR (vₘₐₓ/cm⁻¹, CHCl₃) 3659, 2981, 2888, 1703, 1461, 1153, 955.

MS (ESI) m/z [M+Na]⁺: 219.1(100).

[α]²⁰₅₈₉=+45.8° (c 1.0, CHCl₃).

### Example 14—Synthesis of (−)-(S)-4-ethyl-4,5-dimethylhexan-2-one (3g)

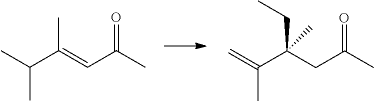

CuCl (1.9 mg, 0.02 mmol, 0.1 eq.), and the phosphoramidite ligand B (11.5 mg, 0.02 mmol, 0.1 eq.) were added to a flame dried round bottom flask containing 1 mL Et₂O under argon and the resulting mixture was stirred at room temperature. After 1 hour, AgOTf (5.6 mg, 0.022 mmol, 0.11 eq.) was added and the mixture was stirred for an additional 15 min. To a second, flame dried, round bottom flask, Cp₂ZrHCl (103 mg, 0.4 mmol, 2.0 eq.) was added. A balloon filled with ethylene was used to purge the flask with ethylene for 5 min, and then CH₂Cl₂ (0.2 mL) was added. After stirring for 15 min under an ethylene atmosphere (balloon), a clear yellow solution was obtained. After stirring for 15 min, the stirred solution containing the copper and ligand was transferred, and filtered—using a syringe filter, to the solution containing the zirconocene species. The resulting black mixture was stirred for another 10 min before the enone (26.0 mg, 0.2 mmol, 1.0 eq.) and then TMSCl (0.127 ml, 1.0 mmol, 5.0 eq.) were each added dropwise. Stirring was continued for 15 h at 0° C., before the reaction was quenched by the addition of 1.5 mL NH₄Cl and then 3.0 mL Et₂O. The mixture was partitioned between the aqueous and organic phases, and the aqueous layer was extracted with Et₂O (3×10 mL). The combined organic materials were dried with Na₂SO₄, filtered, concentrated, and the resulting yellow residual purified by flash column chromatography (Petrol: Et₂O; 90:10; SiO₂) to give the desired product. (15 mg, 48% yield, 95% ee)

GC analysis indicated an enantiomeric excess of 92% Macherey-Nagel Chiral GC Columns® HYDRODEX β-3P; flow, major enantiomer tR=43.14 min; minor enantiomer, tR=44.00 min.

¹H NMR (400 MHz, Chloroform-d) δ_{H}/ppm 2.30 (d, J=1.5 Hz, 2H, CH₂COCH₃), 2.09 (s, 3H, COCH₃), 1.71 (p, J=6.9 Hz, 1H, CH), 1.39 (qd, J=7.5 Hz, 1.2 Hz, 2H, CH₂), 0.85 (s, 3H, CH₃), 0.82-0.69 (m, 9H, CHCH₃, CH₂CH₃).

¹³C NMR (101 MHz, Chloroform-d) δ_{C}/ppm 209.8, 48.7, 38.6, 33.3, 32.7, 29.1, 21.0, 17.3, 17.0, 8.1.

IR (vₘₐₓ/cm⁻¹, CHCl₃) 3659, 2981, 2889, 1510, 1382, 1251, 1152, 1073, 954, 816.

MS (ESI) m/z [M+Na]⁺: found: 179.1 (100)

[α]²⁰₅₈₉=−1.0° (c 1.0, CHCl₃)

### Example 15—Synthesis of (+)-(R)-4-(cyclohexylmethyl)-4-methylhexan-2-one (3h)

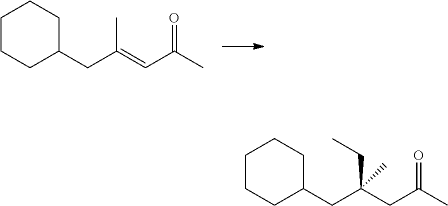

CuCl (1.9 mg, 0.02 mmol, 0.1 eq.), and the phosphoramidite ligand B (11.5 mg, 0.02 mmol, 0.1 eq.) were added to a flame dried round bottom flask containing 1 mL Et₂O under argon and the resulting mixture was stirred at room temperature. After 1 hour, AgOTf (5.6 mg, 0.022 mmol, 0.11 eq.) was added and the mixture was stirred for an additional 15 min. To a second, flame dried, round bottom flask, Cp₂ZrHCl (103 mg, 0.4 mmol, 2.0 eq.) was added. A balloon filled with ethylene was used to purge the flask with ethylene for 5 min, and then CH₂Cl₂ (0.2 mL) was added. After stirring for 15 min under an ethylene atmosphere (balloon), a clear yellow solution was obtained. After stirring for 15 min, the stirred solution containing the copper and ligand was transferred, and filtered—using a syringe filter, to the solution containing the zirconocene species. The resulting black mixture was stirred for another 10 min before the enone (36.0 mg, 0.2 mmol, 1.0 eq.) and then TMSCl (0.127 ml, 1.0 mmol, 5.0 eq.) were each added dropwise. Stirring was continued for 15 h at 0° C., before the reaction was quenched by the addition of 1.5 mL NH₄Cl and then 3.0 mL Et₂O. The mixture was partitioned between the aqueous and organic phases, and the aqueous layer was extracted with Et₂O (3×10 mL). The combined organic materials were dried with Na₂SO₄, filtered, concentrated, and the resulting yellow residual purified by flash column chromatography (Petrol: Et₂O; 90:10; SiO₂) to give the desired product. (30 mg, 71% yield, 98% ee).

HPLC analysis indicated an enantiomeric excess of 98% [Chiralpak® IA; flow: 1.0 mL/min; hexane/i-PrOH: 99:1; λ=222 nm; major enantiomer tR=5.49 min; minor enantiomer, tR=6.42 min].

¹H NMR (400 MHz, Chloroform-d) δ_{H}/ppm 2.32 (s, 2H, COCH₂), 2.11 (s, 3H, COCH₃), 1.74-1.5-(m, 5H, CH₂, CH), 1.49-1.29 (m, 2H, CH₂), 1.32-1.01 (m, 6H, CH₂C), 0.94 (m, 5H, CH₂, CH₃), 0.79 (t, J=7.5 Hz, 3H, CH₂CH₃).

¹³C NMR (101 MHz, Chloroform-d) δ_{C}/ppm 209.2, 51.8, 46.6, 36.9, 35.9(2C), 33.4, 32.6, 32.0, 26.7(2c), 26.3, 24.9, 8.4.

IR (vₘₐₓ/cm⁻¹, CHCl₃) 3659, 2981, 2889, 1715, 1381, 1152, 1072, 954.

MS (ESI) m/z calc. for C₁₄H₂₇O [M+H]⁺: 211.2056, found: 211.2059.

[α]²⁰₅₈₉=+2.2° (c 1.0, CHCl₃).

### Example 16—Synthesis of (−)-(R)-4-benzyl-4-methylhexan-2-one (3i)

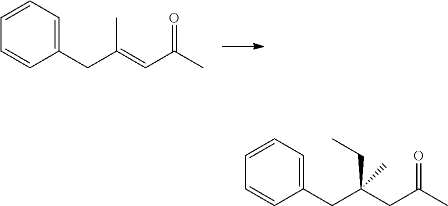

CuCl (1.9 mg, 0.02 mmol, 0.1 eq.), and the phosphoramidite ligand B (11.5 mg, 0.02 mmol, 0.1 eq.) were added to a flame dried round bottom flask containing 1 mL Et₂O under argon and the resulting mixture was stirred at room temperature. After 1 hour, AgOTf (5.6 mg, 0.022 mmol, 0.11 eq.) was added and the mixture was stirred for an additional 15 min. To a second, flame dried, round bottom flask, Cp₂ZrHCl (103 mg, 0.4 mmol, 2.0 eq.) was added. A balloon filled with ethylene was used to purge the flask with ethylene for 5 min, and then CH₂Cl₂ (0.2 mL) was added. After stirring for 15 min under an ethylene atmosphere (balloon), a clear yellow solution was obtained. After stirring for 15 min, the stirred solution containing the copper and ligand was transferred, and filtered—using a syringe filter, to the solution containing the zirconocene species. The resulting black mixture was stirred for another 10 min before the enone (35.0 mg, 0.2 mmol, 1.0 eq.) and then TMSCl (0.127 ml, 1.0 mmol, 5.0 eq.) were each added dropwise. Stirring was continued for 15 h at 0° C., before the reaction was quenched by the addition of 1.5 mL NH₄Cl and then 3.0 mL Et₂O. The mixture was partitioned between the aqueous and organic phases, and the aqueous layer was extracted with Et₂O (3×10 mL). The combined organic materials were dried with Na₂SO₄, filtered, concentrated, and the resulting yellow residual purified by flash column chromatography (Petrol: Et₂O; 95:5; SiO₂) to give the desired product. (25 mg, 61% yield, 93% ee).

HPLC analysis indicated an enantiomeric excess of 93% [Chiralpak® ID; flow: 0.8 mL/min; hexane/i-PrOH: 99:1; λ=210 nm; major enantiomer tR=7.60 min; minor enantiomer, tR=8.25 min].

¹H NMR (400 MHz, Chloroform-d) δ_{H}/ppm 7.28-7.14 (m, 3H, Ar—H), 7.12-7.04 (m, 2H, Ar—H), 2.74 (d, J=13.1 Hz, 1H, PhCH₂), 2.63 (d, J=13.1 Hz, 1H, PhCH₂), 2.23 (d, J=1.9 Hz, 2H, CH₂CO), 2.08 (s, 3H COCH₃), 1.52-1.27 (m, 2H, CH₂CH₃), 0.92 (s, 3H, CH₃), 0.86 (t, J=7.5 Hz, 3H, CH₂CH₃).

¹³C NMR (101 MHz, Chloroform-d) δ_{C}/ppm 209.0, 138.8, 130.6, 127.8(2C), 126.0(2C), 50.1, 44.7, 37.2, 32.4, 31.5, 24.3, 8.4.

IR (vₘₐₓ/cm⁻¹, CHCl₃) 3661, 2970, 1714, 1360, 1153, 703.

MS (ESI) m/z calc. for C₁₄H₂₀O²³Na [M+H]⁺: 227.1406, found: 227.1407.

[α]²⁰₅₈₉=−7.3° (c 1.0, CHCl₃).

### Example 17—Synthesis of (−)-(S)-4-ethyl-4-methyl-7-phenylheptan-2-one (3j)

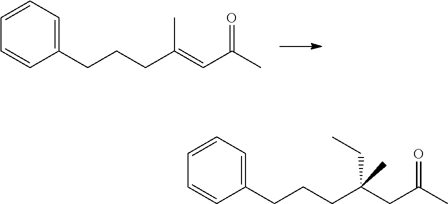 [SMILES: CC(=O)/C=C(\C)CCCc1ccccc1 ; CC[C@@](C)(CCCc1ccccc1)CC(C)=O]

CuCl (1.9 mg, 0.02 mmol, 0.1 eq.), and the R-phosphoramidite ligand B (11.5 mg, 0.02 mmol, 0.1 eq.) were added to a flame dried round bottom flask containing 1 mL Et₂O under argon and the resulting mixture was stirred at room temperature. After 1 hour, AgOTf (5.6 mg, 0.022 mmol, 0.11 eq.) was added and the mixture was stirred for an additional 15 min. To a second, flame dried, round bottom flask, Cp₂ZrHCl (103 mg, 0.4 mmol, 2.0 eq.) was added. A balloon filled with ethylene was used to purge the flask with ethylene for 5 min, and then CH₂Cl₂ (0.2 mL) was added. After stirring for 15 min under an ethylene atmosphere (balloon), a clear yellow solution was obtained. After stirring for 15 min, the stirred solution containing the copper and ligand was transferred, and filtered—using a syringe filter, to the solution containing the zirconocene species. The resulting black mixture was stirred for another 10 min before the enone (40.0 mg, 0.2 mmol, 1.0 eq.) and then TMSCl (0.127 ml, 1.0 mmol, 5.0 eq.) were each added dropwise. Stirring was continued for 15 h at 0° C., before the reaction was quenched by the addition of 1.5 mL NH₄Cl and then 3.0 mL Et₂O. The mixture was partitioned between the aqueous and organic phases, and the aqueous layer was extracted with Et₂O (3×10 mL). The combined organic materials were dried with Na₂SO₄, filtered, concentrated, and the resulting yellow residual purified by flash column chromatography (Petrol: Et₂O; 95:5; SiO₂) to give the desired product. (33 mg, 71% yield, 93% ee).

HPLC analysis indicated an enantiomeric excess of 93% [two Chiralpak® ID in series; flow: 0.8 mL/min; hexane/i-PrOH: 99:1; λ=210 nm; minor enantiomer tR=14.17 min; major enantiomer, tR=14.74 min].

¹H NMR (400 MHz, Chloroform-d) δ_{H}/ppm 7.30-7.15 (m, 2H, Ar—H), 7.15-7.06 (m, 3H, Ar—H), 2.56-2.45 (m, 2H, PhCH₂), 2.23 (s, 2H, CH₂COCH₃), 2.03 (s, 3H, COCH₃), 1.52-1.37 (m, 2H, CH₂), 1.36-1.21 (m, 4H, CH₂), 0.86 (s, 3H, CH₃), 0.70 (t, J=7.5 Hz, 3H, CH₂CH₃).

¹³C NMR (101 MHz, Chloroform-d) δ_{C}/ppm 209.2, 142.7, 128.4(2C), 128.3(2C), 125.7, 51.4, 38.6, 36.7, 36.1, 32.6, 31.7, 25.9, 24.6, 8.1.

IR (vₘₐₓ/cm⁻¹, CHCl₃) 3659, 2980, 2889, 1714, 1381, 1152, 955, 699.

MS (ESI) m/z calc. for C₁₆H₂₄O²³Na [M+H]⁺ 255.1719, found: 255.1719.

[α]²⁰₅₈₉=−3.10 (c 1.3, CHCl₃).

### Example 18—Synthesis of (−)-(S)-5-ethyl-5-methyl-7-phenylheptan-3-one (3k)

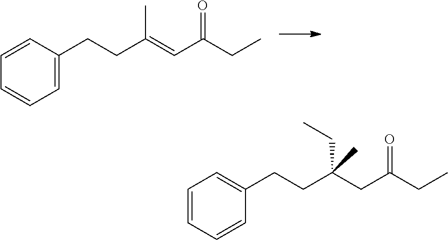 [SMILES: CCC(=O)/C=C(\C)CCc1ccccc1 ; CCC(=O)C[C@@](C)(CC)CCc1ccccc1]

CuCl (1.9 mg, 0.02 mmol, 0.1 eq.), and the R-phosphoramidite ligand B (11.5 mg, 0.02 mmol, 0.1 eq.) were added to a flame dried round bottom flask containing 1 mL Et₂O under argon and the resulting mixture was stirred at room temperature. After 1 hour, AgOTf (5.6 mg, 0.022 mmol, 0.11 eq.) was added and the mixture was stirred for an additional 15 min. To a second, flame dried, round bottom flask, Cp₂ZrHCl (103 mg, 0.4 mmol, 2.0 eq.) was added. A balloon filled with ethylene was used to purge the flask with ethylene for 5 min, and then CH₂Cl₂ (0.2 mL) was added. After stirring for 15 min under an ethylene atmosphere (balloon), a clear yellow solution was obtained. After stirring for 15 min, the stirred solution containing the copper and ligand was transferred, and filtered—using a syringe filter, to the solution containing the zirconocene species. The resulting black mixture was stirred for another 10 min before the enone (41.0 mg, 0.2 mmol, 1.0 eq.) and then TMSCl (0.127 ml, 1.0 mmol, 5.0 eq.) were each added dropwise. Stirring was continued for 15 h at 0° C., before the reaction was quenched by the addition of 1.5 mL NH₄Cl and then 3.0 mL Et₂O. The mixture was partitioned between the aqueous and organic phases, and the aqueous layer was extracted with Et₂O (3×10 mL). The combined organic materials were dried with Na₂SO₄, filtered, concentrated, and the resulting yellow residual purified by flash column chromatography (Petrol: Et₂O; 95:5; SiO₂) to give the desired product. (37 mg, 80% yield, 96% ee).

HPLC analysis indicated an enantiomeric excess of 96% [Chiralpak® AYH; flow: 0.4 mL/min; hexane/i-PrOH: 99.2:0.8; λ=210 nm; minor enantiomer tR=15.66 min; major enantiomer, tR=16.39 min].

¹H NMR (400 MHz, Chloroform-d) δ_{H}/ppm 7.20 (dd, J=7.9 Hz, 6.8 Hz, 2H, Ar—H), 7.16-7.06 (m, 3H, Ar—H), 2.61-2.39 (m, 2H, PhCH₂), 2.34 (q, J=7.3 Hz, 2H, COCH₂CH₃), 2.29 (s, 2H, COCH₂), 1.65-1.50 (m, 2H, PhCH₂CH₂), 1.44-1.30 (m, 2H, CH₂CH₃), 1.02-0.86 (m, 6H, CH₃), 0.78 (t, J=7.5 Hz, 3H, CH₂CH₃).

¹³C NMR (101 MHz, Chloroform-d) δ_{C}/ppm 211.4, 143.1, 128.4(2C), 128.4(2C), 125.6, 50.0, 41.2, 38.4, 36.4, 31.7, 30.4, 24.7, 8.2, 7.8.

IR (vₘₐₓ/cm⁻¹, CHCl₃) 3026, 2937, 1711, 1455, 1107, 1030, 698.

MS (ESI) m/z calc. for C₁₆H₂₄O²³Na [M+H]⁺: 255.1719, found: 255.1719.

[α]²⁰₅₈₉=−7.9° (c 1.4, CHCl₃).

### Example 19—Synthesis of (−)-(S)-3-ethyl-3-methyl-1-phenyldecan-5-one (31)

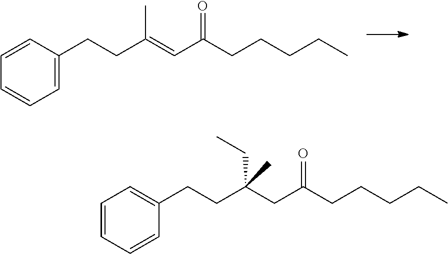 [SMILES: CCCCCC(=O)/C=C(\C)CCc1ccccc1 ; CCCCCC(=O)C[C@@](C)(CC)CCc1ccccc1]

CuCl (1.9 mg, 0.02 mmol, 0.1 eq.), and the R-phosphoramidite ligand B (11.5 mg, 0.02 mmol, 0.1 eq.) were added to a flame dried round bottom flask containing 1 mL Et₂O under argon and the resulting mixture was stirred at room temperature. After 1 hour, AgOTf (5.6 mg, 0.022 mmol, 0.11 eq.) was added and the mixture was stirred for an additional 15 min. To a second, flame dried, round bottom flask, Cp₂ZrHCl (103 mg, 0.4 mmol, 2.0 eq.) was added. A balloon filled with ethylene was used to purge the flask with ethylene for 5 min, and then CH₂Cl₂ (0.2 mL) was added. After stirring for 15 min under an ethylene atmosphere (balloon), a clear yellow solution was obtained. After stirring for 15 min, the stirred solution containing the copper and ligand was transferred, and filtered—using a syringe filter, to the solution containing the zirconocene species. The resulting black mixture was stirred for another 10 min before the enone (50.0 mg, 0.2 mmol, 1.0 eq.) and then TMSCl (0.127 ml, 1.0 mmol, 5.0 eq.) were each added dropwise. Stirring was continued for 15 h at 0° C., before the reaction was quenched by the addition of 1.5 mL NH₄Cl and then 3.0 mL Et₂O. The mixture was partitioned between the aqueous and organic phases, and the aqueous layer was extracted with Et₂O (3×10 mL). The combined organic materials were dried with Na₂SO₄, filtered, concentrated, and the resulting yellow residual purified by flash column chromatography (Petrol: Et₂O; 95:5; SiO₂) to give the desired product. (30 mg, 54% yield, 96% ee).

HPLC analysis indicated an enantiomeric excess of 91% [two Chiralpak® IA in series; flow: 0.8 mL/min; hexane/i-PrOH: 99.4:0.6; λ=210 nm; minor enantiomer, tR=12.72 min, major enantiomer tR=13.33 min;].

¹H NMR (400 MHz, Chloroform-d) δ_{H}/ppm 7.20 (td, J=7.3 Hz, 1.7, 2H, Ar—H), 7.11 (dt, J=8.1 Hz, 1.9, 3H, Ar—H), 2.51-2.39 (m, 2H,), 2.32 (d, J=7.3, 2H, PhCH₂), 2.29 (s, 2H, CH₂CO), 1.61-1.53 (m, 2H, PhCH₂CH₂), 1.49 (dd, J=12.9 Hz, 5.5 Hz, 2H, CH₂), 1.44-1.33 (m, 2H, CH₂), 1.21 (dddd, J=15.8 Hz, 14.1 Hz, 7.3 Hz, 4.2 Hz, 4H, CH₂), 0.94 (s, 3H, CH₃), 0.80 (dt, J=13.2, 7.2, 6H, CH₂CH₃, CH₂CH₂CH₃).

¹³C NMR (101 MHz, Chloroform-d) δ_{C}/ppm 211.2, 143.1, 128.4(2C), 128.3(2C), 125.6, 50.3, 45.3, 41.2, 36.4, 31.7, 31.4, 30.4, 24.7, 23.5, 22.5, 14.0, 8.1.

IR (vₘₐₓ/cm⁻¹, CHCl₃) 3063, 2931, 1711, 1456, 1031, 699.

MS (ESI) m/z calc. for C₁₉H₃₀O²³Na [M+Na]⁺: 297.2189, found: 297.2188.

[α]²⁰₅₈₉=−5.9° (c 1.0, CHCl₃).

### Example 20—Synthesis (+)-(R)-5-methyl-5-phenethylnonan-3-one (3m)

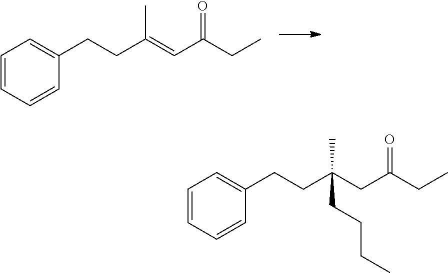

CuCl (1.9 mg, 0.02 mmol, 0.10 eq.), and the phosphoramidite ligand B (11.5 mg, 0.02 mmol, 0.10 eq) were added to a flame dried round bottom flask containing 1 mL Et₂O under argon and the resulting mixture was stirred at room temperature. After 1 hour, AgOTf (5.6 mg, 0.022 mmol, 0.11 eq) was added and the mixture was stirred for an additional 15 min. To a second, flame dried, round bottom flask, Cp₂ZrHCl (103 mg, 0.4 mmol, 2.0 eq) was added. A balloon filled with 1-butene was used to purge the flask 1-butene for 5 min, and then CH₂Cl₂ (0.2 mL) was added. After stirring for 15 min under a 1-butene atmosphere (balloon), a clear yellow solution was obtained. After stirring for 15 min, the stirred solution containing the copper and ligand was transferred, and filtered—using a syringe filter, to the solution containing the zirconocene species. The resulting black mixture was stirred for another 10 min before the enone (40.0 mg, 0.2 mmol, 1.0 eq) and then TMSCl (0.127 ml, 1.0 mmol, 5.0 eq) were each added dropwise. Stirring was continued for 15 h at 0° C., before the reaction was quenched by the addition of 1.5 mL NH₄Cl and then 3.0 mL Et₂O. The mixture was partitioned between the aqueous and organic phases, and the aqueous layer was extracted with Et₂O (3×10 mL). The combined organic materials were dried with Na₂SO₄, filtered, concentrated, and the resulting yellow residual purified by flash column chromatography (Petrol: Et₂O; 95:5; SiO₂) to give the desired product. (25 mg, 53% yield, 93% ee).

HPLC analysis indicated an enantiomeric excess of 91% [Chiralpak® IA; flow: 1.0 mL/min; hexane/i-PrOH: 99.7:0.3; λ=210 nm; major enantiomer tR=5.56 min; minor enantiomer, tR=5.79 min].

¹H NMR (400 MHz, Chloroform-d) δ_{H}/ppm 7.31-7.22 (m, 2H, Ar—H), 7.16 (dt, J=8.1 Hz, 1.9 Hz, 3H, Ar—H), 2.56-2.47 (m, 2H, PhCH₂), 2.39 (q, J=7.3 Hz, 2H, COCH₂CH₃), 2.36 (s, 2H, COCH₂), 1.69-1.58 (m, 2H, PhCH₂CH₂), 1.44-1.34 (m, 2H, CH₂), 1.34-1.12 (m, 4H, CH₂), 1.08-0.95 (m, 6H, CH₃), 0.90 (t, J=7.1 Hz, 3H, CH₂CH₃).

¹³C NMR (101 MHz, Chloroform-d) δ_{C}/ppm 211.4, 143.1, 128.4(2C), 128.3(2C), 125.6, 50.5, 41.7, 39.3, 38.4, 36.3, 30.4, 26.0, 25.2, 23.5, 14.2, 7.8.

IR (vₘₐₓ/cm⁻¹, CHCl₃) 3658, 2980, 2888, 1382, 1252, 1152, 1073, 954.

MS (ESI) m/z calc. for C₁₈H₂₉O [M+H]⁺: 261.2213, found: 261.2215.

[α]²⁰₅₈₉=+3.8° (c 1.0, CHCl₃).

### Example 21—Synthesis of (+)-(R)-5,8-dimethyl-5-phenethylnonan-3-one (3n)

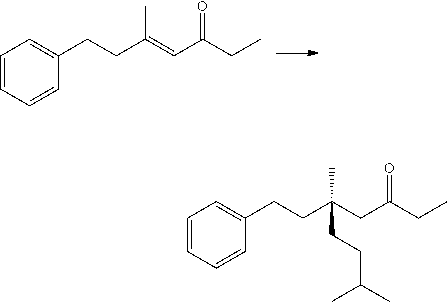

CuCl (1.9 mg, 0.02 mmol, 0.10 eq.), and the phosphoramidite ligand B (11.5 mg, 0.02 mmol, 0.10 eq) were added to a flame dried round bottom flask containing 1 mL Et₂O under argon and the resulting mixture was stirred at room temperature. After 1 hour, AgOTf (5.6 mg, 0.022 mmol, 0.11 eq) was added and the mixture was stirred for an additional 15 min. To a second, flame dried, round bottom flask, Cp₂ZrHCl (103 mg, 0.4 mmol, 2.0 eq) was added. A balloon filled with 3 methyl-1 butene was used to purge the flask with 3 methyl-1 butene for 5 min, and then CH₂Cl₂ (0.2 mL) was added. After stirring for 15 min under a 3 methyl-1 butene atmosphere (balloon), a clear yellow solution was obtained. After stirring for 15 min, the stirred solution containing the copper and ligand was transferred, and filtered—using a syringe filter, to the solution containing the zirconocene species. The resulting black mixture was stirred for another 10 min before the enone (40.0 mg, 0.2 mmol, 1.0 eq) and then TMSCl (0.127 ml, 1.0 mmol, 5.0 eq) were each added dropwise. Stirring was continued for 15 h at 0° C., before the reaction was quenched by the addition of 1.5 mL NH₄Cl and then 3.0 mL Et₂O. The mixture was partitioned between the aqueous and organic phases, and the aqueous layer was extracted with Et₂O (3×10 mL). The combined organic materials were dried with Na₂SO₄, filtered, concentrated, and the resulting yellow residual purified by flash column chromatography (Petrol: Et₂O; 95:5; SiO₂) to give the desired product. (40 mg, 70% yield, 90% ee).

HPLC analysis indicated an enantiomeric excess of 91% [Chiralpak® AYH; flow: 1.0 mL/min; hexane/i-PrOH: 99.5:0.5; λ=210 nm; major enantiomer tR=4.26 min; minor enantiomer, tR=4.45 min].

¹H NMR (400 MHz, Chloroform-d) δ_{H}/ppm 7.20 (dd, J=8.1 Hz, 6.9 Hz, 2H, Ar—H), 7.11 (dt, J=8.0 Hz, 1.8 Hz, 3H, Ar—H), 2.51-2.39 (m, 2H, PhCH₂), 2.33 (q, J=7.3 Hz, 2H, COCH₂CH₃), 2.29 (s, 2H, COCH₂), 1.64-1.49 (m, 2H, PhCH₂CH₂), 1.47-1.35 (m, 1H, CH), 1.35-1.28 (m, 2H, CH₂), 1.15-1.01 (m, 2H, CH₂), 1.01-0.89 (m, 6H), 0.82 (d, J=6.6 Hz, 6H, CH₃).

¹³C NMR (101 MHz, Chloroform-d) δ_{C}/ppm 211.3, 143.1, 128.4(2C), 128.3(2C), 125.6, 50.5, 41.6, 38.4, 37.1, 36.2, 32.8, 30.4, 28.7, 25.2, 22.8(2C), 7.8.

IR (vₘₐₓ/cm⁻¹, CHCl₃) 3659, 2981, 2885, 1510, 1381, 1165, 956, 741.

MS (ESI) m/z calc. for C₁₉H₃₁O [M+H]⁺: 275.2369, found: 275.2372.

[α]²⁰₅₈₉=+4.3° (c 1.0, CHCl₃).

### Example 22—Synthesis of (+)-(S)-5,8,8-trimethyl-5-phenethylnonan-3-one (3o)

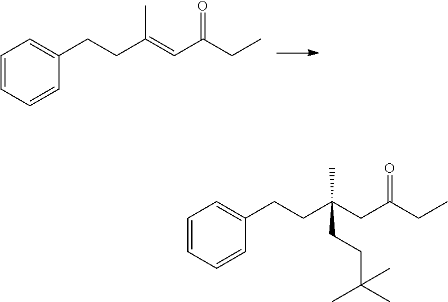

CuCl (1.9 mg, 0.02 mmol, 0.10 eq), and the phosphoramidite ligand B (11.6 mg, 0.02 mmol, 0.10 eq) were added to a flame dried round bottom flask containing 1 mL Et₂O under argon and the resulting mixture was stirred at room temperature. After 1 hour, AgOTf (5.6 mg, 0.022 mmol, 0.11 eq) was added and the mixture was stirred for an additional 15 min.

To a second, flame dried, round bottom flask, containing a stirred solution of 3,3-dimethyl-1-butene (0.15 ml, 0.5 mmol, 2.5 eq.) in CH₂Cl₂ (0.4 mL), under an argon atmosphere was added Cp₂ZrHCl (103 mg, 0.4 mmol, 2.0 eq), and was heated at 40° C. for 1 h before being cooled to room temperature once the hydrozirconation was complete. A clear yellow solution was obtained.

The stirred solution containing the copper and ligand was transferred, and filtered—using a syringe filter, to the solution containing the zirconocene species. The resulting black mixture was stirred for another 10 min before enone (40 mg, 0.2 mmol, 1.0 eq.) and TMSCl (0.127 ml, 1.0 mmol, 5.0 eq) were sequentially added dropwise over about 1 min for each. Stirring at 0° C. was continued for 15 additional hours, before the reaction was quenched by the addition of 1.5 mL NH₄Cl (sat. aq.) and then 3.0 mL Et₂O. The reaction mixture was partitioned between the aqueous and organic phases, and the aqueous layer extracted by Et₂O (3×10 mL). The combined organic materials were dried (Na₂SO₄), filtered, concentrated, and the resulting yellow residual purified by flash column chromatography (Petrol: Et₂O; 95:5; SiO₂) to give the desired product. (39 mg, 69% yield, 85% ee).

HPLC analysis indicated an enantiomeric excess of 91% [Chiralpak® IA; flow: 1.0 mL/min; hexane/i-PrOH: 99.5:0.5; λ=210 nm; major enantiomer tR=4.34 min; minor enantiomer, tR=4.54 min].

¹H NMR (400 MHz, Chloroform-d) δ_{H}/ppm 7.37-7.26 (m, 2H, Ar—H), 7.26-7.16 (m, 3H, Ar—H), 2.61-2.51 (m, 2H, PhCH₂), 2.45 (q, J=7.3 hz, 2H, COCH₂CH₃), 2.40 (s, 2H, COCH₂), 1.67 (ddt, J=10.9 Hz, 7.4 Hz, 1.7 Hz, 2H, PhCH₂CH), 1.46-1.30 (m, 2H, CH₂), 1.23-1.11 (m, 2H, CH₂), 1.11-1.01 (m, 6H, CH₂CH₃), 0.92 (s, 9H, C (CH₃)₃).

¹³C NMR (101 MHz, Chloroform-d) δ_{C}/ppm 211.3, 143.1, 128.4(4C), 125.6, 50.5, 41.5, 38.4, 37.4, 36.0, 33.7, 30.4, 30.2, 29.4 (3C), 25.2, 7.8.

IR (vₘₐₓ/cm⁻¹, CHCl₃) 3658, 2980, 2888, 1382, 1251, 1152, 955.

MS (ESI) m/z calc. for C₂₀H₃₃O [M+H]⁺: 289.2526, found: 289.2528.

[α]²⁰₅₈₉=+2.1° (c 1.0, CHCl₃).

### Example 23—Synthesis of (+)-(R)-5-methyl-5-phenethyltridecan-3-one (3p)

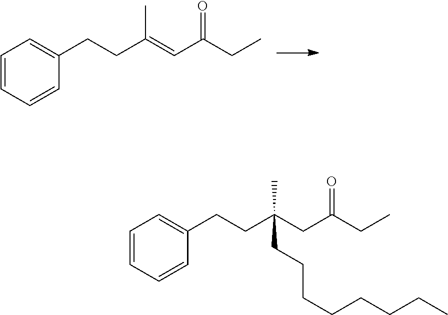

CuCl (1.9 mg, 0.02 mmol, 0.10 eq), and the phosphoramidite ligand B (11.6 mg, 0.02 mmol, 0.10 eq) were added to a flame dried round bottom flask containing 1 mL Et₂O under argon and the resulting mixture was stirred at room temperature. After 1 hour, AgOTf (5.6 mg, 0.022 mmol, 0.11 eq) was added and the mixture was stirred for an additional 15 min.

To a second, flame dried, round bottom flask, containing a stirred solution of Octene (0.1 ml, 0.5 mmol, 2.5 eq.) in CH₂Cl₂ (0.2 mL), under an argon atmosphere was added Cp₂ZrHCl (103 mg, 0.4 mmol, 2.0 eq), and after stirring for 15 min, a clear yellow solution was obtained.

The stirred solution containing the copper and ligand was transferred, and filtered—using a syringe filter, to the solution containing the zirconocene species. The resulting black mixture was stirred for another 10 min before enone (40 mg, 0.2 mmol, 1.0 eq.) and TMSCl (0.127 ml, 1.0 mmol, 5.0 eq) were sequentially added dropwise over about 1 min for each. Stirring at 0° C. was continued for 15 additional hours, before the reaction was quenched by the addition of 1.5 mL NH₄Cl (sat. aq.) and then 3.0 mL Et₂O. The reaction mixture was partitioned between the aqueous and organic phases, and the aqueous layer extracted by Et₂O (3×10 mL). The combined organic materials were dried (Na₂SO₄), filtered, concentrated, and the resulting yellow residual purified by flash column chromatography (Petrol: Et₂O; 95:5; SiO₂) to give the desired product. (35 mg, 56% yield, 92% ee)

HPLC analysis indicated an enantiomeric excess of 92% [Chiralpak® IA; flow: 0.8 mL/min; hexane/i-PrOH: 99.8:0.2; λ=210 nm; major enantiomer tR=8.01 min; minor enantiomer, tR=8.62 min].

¹H NMR (400 MHz, Chloroform-d) δ_{H}/ppm 7.38-7.25 (m, 2H, Ar—H), 7.21 (dt, J=8.0 Hz, 1.9 Hz, 3H, Ar—H), 2.61-2.51 (m, 2H, PhCH₂), 2.49-2.41 (m, 2H, COCH₂CH₃), 2.40 (s, 2H, CH₂CO), 1.79-1.56 (m, 2H, CH₂), 1.41 (t, J=7.4 Hz, 2H, CH₂), 1.38-1.18 (m, 12H, CH₂, CH₃), 1.13-1.01 (m, 6H, CH₂), 0.92 (t, J=6.8 Hz, 3H, CH₃).

¹³C NMR (101 MHz, Chloroform-d) δ_{C}/ppm 211.4, 143.1, 128.4(2C), 128.3(2C), 125.6, 50.5, 41.7, 39.6, 38.4, 36.3, 31.9, 30.5(2C), 29.7, 29.4, 25.2, 23.7, 22.7, 14.1, 7.8.

IR (vₘₐₓ/cm⁻¹, CHCl₃) 3659, 2980, 2889, 1382, 1252, 1153, 1073, 954.

MS (ESI) m/z calc. for C₂₂H₃₇O [M+H]⁺: 317.2839, found: 317.2841.

[α]²⁰₅₈₉=+4.7° (c 1.0, CHCl₃).

### Example 24—Synthesis of (+)-(R)-5-methyl-5-phenethylnonadecan-3-one (3q)

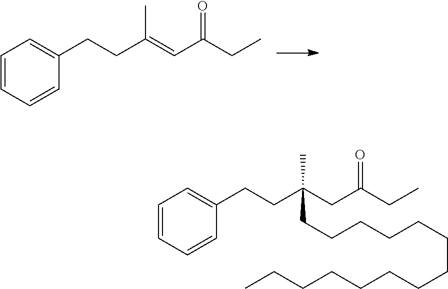

CuCl (1.9 mg, 0.02 mmol, 0.10 eq), and the phosphoramidite ligand B (11.6 mg, 0.02 mmol, 0.10 eq) were added to a flame dried round bottom flask containing 1 mL Et₂O under argon and the resulting mixture was stirred at room temperature. After 1 hour, AgOTf (5.6 mg, 0.022 mmol, 0.11 eq) was added and the mixture was stirred for an additional 15 min.

To a second, flame dried, round bottom flask, containing a stirred solution of 1-tetradecene (0.15 ml, 0.5 mmol, 2.5 eq.) in CH₂Cl₂ (0.2 mL), under an argon atmosphere was added Cp₂ZrHCl (103 mg, 0.4 mmol, 2.0 eq), and after stirring for 15 min, a clear yellow solution was obtained.

The stirred solution containing the copper and ligand was transferred, and filtered—using a syringe filter, to the solution containing the zirconocene species. The resulting black mixture was stirred for another 10 min before enone (40 mg, 0.2 mmol, 1.0 eq.) and TMSCl (0.127 ml, 1.0 mmol, 5.0 eq) were sequentially added dropwise over about 1 min for each. Stirring at 0° C. was continued for 15 additional hours, before the reaction was quenched by the addition of 1.5 mL NH₄Cl (sat. aq.) and then 3.0 mL Et₂O. The reaction mixture was partitioned between the aqueous and organic phases, and the aqueous layer extracted by Et₂O (3×10 mL). The combined organic materials were dried (Na₂SO₄), filtered, concentrated, and the resulting yellow residual purified by flash column chromatography (Petrol: Et₂O; 95:5; SiO₂) to give the desired product. (45 mg, 59% yield, 90% ee).

HPLC analysis indicated an enantiomeric excess of 91% [Chiralpak® IA; flow: 1.0 mL/min; hexane/i-PrOH: 99.8:0.2; λ=210 nm; major enantiomer tR=6.28 min; minor enantiomer, tR=6.89 min].

¹H NMR (400 MHz, Chloroform-d) δ_{H}/ppm 7.35-7.25 (m, 2H, Ar—H), 7.21 (dt, J=8.0 Hz, 1.8 Hz, 3H, Ar—H), 2.62-2.50 (m, 2H, PhCH₂), 2.44 (q, J=7.3, 2H, COCH₂CH₃), 2.40 (s, 2H, COCH₂), 1.75-1.58 (m, 2H, PhCH₂CH₂), 1.49-1.36 (m, 2H, CH₂), 1.29 (s, 24H, CH₂), 1.15-0.98 (m, 6H, CH₃, COCH₂CH₃), 0.99-0.80 (m, 3H, CH₂CH₃).

¹³C NMR (101 MHz, Chloroform-d) δ_{C}/ppm 211.4, 143.1, 128.4 (2C), 128.3(2C), 125.6, 50.5, 41.7, 39.6, 38.4, 36.3, 31.9, 30.5, 29.7 (8C), 29.4, 25.2, 23.7, 22.7, 14.1, 7.8.

IR (vₘₐₓ/cm⁻¹, CHCl₃) 3658, 2980, 2880, 1473, 1382, 1252, 1152, 1072, 954.

MS (ESI) m/z calc. for C₂₈H₄₈O²³Na [M+Na]⁺: 423.3597, found: 423.3596.

[α]²⁰₅₈₉=+2.9° (c 1.0, CHCl₃).

### Example 25—Synthesis of (+)-(R)-7-cyclohexyl-5-methyl-5-phenethylheptan-3-one (3r)

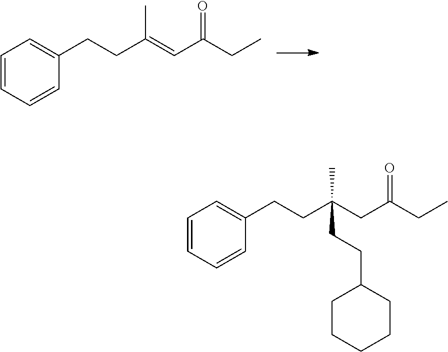

CuCl (1.9 mg, 0.02 mmol, 0.10 eq), and the phosphoramidite ligand B (11.6 mg, 0.02 mmol, 0.10 eq) were added to a flame dried round bottom flask containing 1 mL Et₂O under argon and the resulting mixture was stirred at room temperature. After 1 hour, AgOTf (5.6 mg, 0.022 mmol, 0.11 eq) was added and the mixture was stirred for an additional 15 min.

To a second, flame dried, round bottom flask, containing a stirred solution of vinylcyclohexane (0.08 ml, 0.5 mmol, 2.5 eq.) in CH₂Cl₂ (0.2 mL), under an argon atmosphere was added Cp₂ZrHCl (103 mg, 0.4 mmol, 2.0 eq), and after stirring for 15 min, a clear yellow solution was obtained.

The stirred solution containing the copper and ligand was transferred, and filtered—using a syringe filter, to the solution containing the zirconocene species. The resulting black mixture was stirred for another 10 min before enone (40 mg, 0.2 mmol, 1.0 eq.) and TMSCl (0.127 ml, 1.0 mmol, 5.0 eq) were sequentially added dropwise over about 1 min for each. Stirring at 0° C. was continued for 15 additional hours, before the reaction was quenched by the addition of 1.5 mL NH₄Cl (sat. aq.) and then 3.0 mL Et₂O. The reaction mixture was partitioned between the aqueous and organic phases, and the aqueous layer extracted by Et₂O (3×10 mL). The combined organic materials were dried (Na₂SO₄), filtered, concentrated, and the resulting yellow residual purified by flash column chromatography (Petrol: Et₂O; 95:5; SiO₂) to give the desired product. (40 mg, 64% yield, 90% ee).

HPLC analysis indicated an enantiomeric excess of 90% [Chiralpak® IA; flow: 1.0 mL/min; hexane/i-PrOH: 99.5:0.5; λ=210 nm; major enantiomer tR=5.02 min; minor enantiomer, tR=5.22 min].

¹H NMR (400 MHz, Chloroform-d) δ_{H}/ppm 7.30-7.19 (m, 2H, Ar—H), 7.19-7.08 (m, 3H, Ar—H), 2.54-2.45 (m, 2H, PhCH₂), 2.38 (q, J=7.3 Hz, 2H COCH₂CH₃), 2.33 (s, 2H, COCH₂), 1.74-1.53 (m, 6H, PhCH₂CH₂, CH, CH₂), 1.44-1.31 (m, 2H, CH₂), 1.27-1.03 (m, 6H, CH₂), 1.03-0.97 (m, 6H, CH₂), 0.85 (ddd, J=23.7 Hz, 12.0 Hz, 6.2, 3H, CH₂CH₃).

¹³C NMR (101 MHz, Chloroform-d) δ_{C}/ppm 211.4, 143.1, 128.4(2C), 128.3(2C), 125.6, 50.5, 41.6, 38.4 (2C), 36.6, 36.2, 33.6(2C), 31.3, 30.4, 26.7, 26.5(2C), 25.2, 7.8.

IR (vₘₐₓ/cm⁻¹, CHCl₃) 3658, 2980, 2889, 1382, 1252, 1152, 1073, 955.

MS (ESI) m/z calc. for C₂₂H₃₅O [M+H]⁺: 315.2682, found: 315.2685.

[α]²⁰₅₈₉=+3.5° (c 1.0, CHCl₃).

### Example 26—Synthesis of (+)-(R)-10-chloro-4-methyl-4-phenethyldecan-2-one (3s)

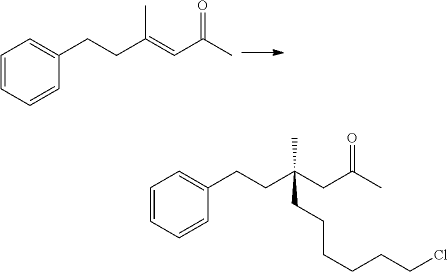

CuCl (1.9 mg, 0.02 mmol, 0.1 eq.), and the phosphoramidite ligand B (11.6 mg, 0.02 mmol) were added to a flame dried round bottom flask containing 1 mL Et₂O under argon and the resulting mixture was stirred at room temperature. After 1 hour, AgOTf (5.6 mg, 0.022 mmol, 0.11 eq.) was added and the mixture was stirred for an additional 15 min.

To a second, flame dried, round bottom flask, containing a stirred solution of 6-chlorohex-1-ene (0.08 ml, 0.5 mmol, 2.5 eq.) in CH₂Cl₂ (0.2 mL), under an argon atmosphere was added Cp₂ZrHCl (103 mg, 0.4 mmol, 2.0 eq.), and after stirring for 15 min, a clear yellow solution was obtained.

The stirred solution containing the copper and ligand was transferred, and filtered—using a syringe filter, to the solution containing the zirconocene species. The resulting black mixture was stirred for another 10 min before enone (38 mg, 0.2 mmol, 1.0 eq.) and TMSCl (0.127 ml, 1.0 mmol, 5.0 eq.) were sequentially added dropwise over about 1 min for each. Stirring at 0° C. was continued for 15 additional hours, before the reaction was quenched by the addition of 1.5 mL NH₄Cl (sat. aq.) and then 3.0 mL Et₂O. The reaction mixture was partitioned between the aqueous and organic phases, and the aqueous layer extracted by Et₂O (3×10 mL). The combined organic materials were dried (Na₂SO₄), filtered, concentrated, and the resulting yellow residual purified by flash column chromatography (Petrol: Et₂O; 80:20; SiO₂) to give the desired product. (31 mg, 51% yield, 84% ee).

HPLC analysis indicated an enantiomeric excess of 91% [Chiralpak® IA; flow: 0.8 mL/min; hexane/i-PrOH: 98.5:1.5; λ=210 nm; major enantiomer tR=6.70 min; minor enantiomer, tR=7.27 min].

¹H NMR (400 MHz, Chloroform-d) δ_{H}/ppm 7.23-7.12 (m, 2H, Ar—H), 7.11-7.02 (m, 3H, Ar—H), 3.43 (t, J=6.7 Hz, 2H, CH2Cl), 2.42 (t, J=8.7 Hz, 2H, PhCH₂), 2.30 (s, 2H, CH₂COCH₃), 2.03 (s, 3H, COCH₃), 1.78-1.57 (m, 3H, CH₂), 1.57-1.45 (m, 2H, CH₂), 1.41-1.23 (m, 3H, CH₂), 1.28-1.07 (m, 4H, CH₂), 0.94 (s, 3H, CH₃).

¹³C NMR (101 MHz, Chloroform-d) δ_{C}/ppm 208.7, 142.9, 128.4(2C), 128.3(2C), 125.7, 51.6, 45.1, 41.6, 39.3, 36.2, 32.6(2C), 30.4, 29.7, 26.9, 25.1, 23.6.

IR (vₘₐₓ/cm⁻¹, CHCl₃) 3658, 2981, 2889, 1382, 1252, 1153, 955.

MS (ESI) m/z calc. for C₁₉H₃₀O³^{⁵}Cl [M+H]⁺: 309.1979, found: 309.1981.

[α]²⁰₅₈₉=+1.0° (c 1.0, CHCl₃).

### Example 27—Synthesis of (−)-(R)-9-bromo-4-methyl-4-phenethylnonan-2-one (3t)

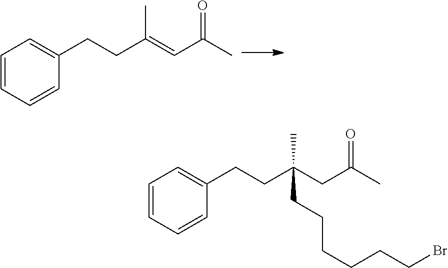

CuCl (1.9 mg, 0.02 mmol, 0.1 eq.), and the phosphoramidite ligand B (11.6 mg, 0.02 mmol) were added to a flame dried round bottom flask containing 1 mL Et₂O under argon and the resulting mixture was stirred at room temperature. After 1 hour, AgOTf (5.6 mg, 0.022 mmol, 0.11 eq.) was added and the mixture was stirred for an additional 15 min.

To a second, flame dried, round bottom flask, containing a stirred solution of 5-bromo-1 pentene (0.06 ml, 0.5 mmol, 2.5 eq.) in CH₂Cl₂ (0.2 mL), under an argon atmosphere was added Cp₂ZrHCl (103 mg, 0.4 mmol, 2.0 eq.), and after stirring for 15 min, a clear yellow solution was obtained.

The stirred solution containing the copper and ligand was transferred, and filtered—using a syringe filter, to the solution containing the zirconocene species. The resulting black mixture was stirred for another 10 min before enone (38 mg, 0.2 mmol, 1.0 eq.) and TMSCl (0.127 ml, 1.0 mmol, 5.0 eq.) were sequentially added dropwise over about 1 min for each. Stirring at 0° C. was continued for 15 additional hours, before the reaction was quenched by the addition of 1.5 mL NH₄Cl (sat. aq.) and then 3.0 mL Et₂O. The reaction mixture was partitioned between the aqueous and organic phases, and the aqueous layer extracted by Et₂O (3×10 mL). The combined organic materials were dried (Na₂SO₄), filtered, concentrated, and the resulting yellow residual purified by flash column chromatography (Petrol: Et₂O; 95:5; SiO₂) to give the desired product. (37 mg, 55% yield, 87% ee).

HPLC analysis indicated an enantiomeric excess of 87% [Chiralpak® IA; flow: 1.0 mL/min; hexane/i-PrOH: 99:1; λ=210 nm; major enantiomer tR=6.22 min; minor enantiomer, tR=6.73 min].

¹H NMR (400 MHz, Chloroform-d) δ_{H}/ppm 7.25-7.16 (m, 2H, Ar—H), 7.15-7.06 (m, 3H, Ar—H), 3.34 (t, J=6.8 Hz, 2H, CH₂Br), 2.62-2.40 (m, 2H, PhCH₂), 2.33 (s, 2H, CH₂COCH₃), 2.07 (s, 3H, COCH₃), 1.80 (dq, J=8.9 Hz, 6.9 Hz, 2H, CH₂), 1.57 (ddd, J=11.9 Hz, 5.9 Hz, 3.2 Hz, 2H, CH₂), 1.48-1.29 (m, 4H, CH₂), 1.29-1.10 (m, 2H, CH₂), 0.97 (s, 3H, CH₃).

¹³C NMR (101 MHz, Chloroform-d) δ_{C}/ppm 208.7, 142.8, 128.4(2C), 128.3(2C), 125.7, 51.6, 41.6, 39.2, 36.2, 33.9, 32.7, 32.7, 30.4, 28.9, 25.1, 22.9.

IR (vₘₐₓ/cm⁻¹, CHCl₃) 3659, 2981, 2885, 1510, 1381, 1165, 956, 741.

MS (ESI) m/z calc. for C₁₉H₃₀O⁷⁹Br [M+Na]⁺: 353.1475, found: 353.1473.

[α]²⁰₅₈₉=−1.2° (c 1.0, CHCl₃).

### Example 28—Synthesis of (−)-(R)-4-methyl-4-phenethyl-8-phenyloct-7-yn-2-one (3u)

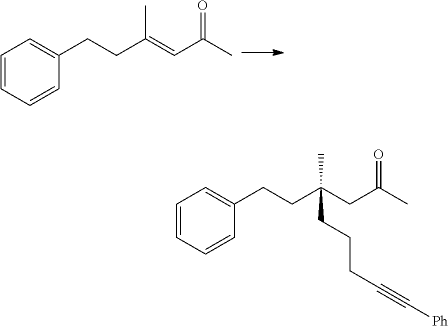

CuCl (1.9 mg, 0.02 mmol, 0.1 eq.), and the phosphoramidite ligand B (11.6 mg, 0.02 mmol) were added to a flame dried round bottom flask containing 1 mL Et₂O under argon and the resulting mixture was stirred at room temperature. After 1 hour, AgOTf (5.6 mg, 0.022 mmol, 0.11 eq.) was added and the mixture was stirred for an additional 15 min.

To a second, flame dried, round bottom flask, containing a stirred solution of pent-4-en-1-yn-1-ylbenzene (0.08 ml, 0.5 mmol, 2.5 eq.) in CH₂Cl₂ (0.2 mL), under an argon atmosphere was added Cp₂ZrHCl (103 mg, 0.4 mmol, 2.0 eq.), and after stirring for 15 min, a clear yellow solution was obtained.

The stirred solution containing the copper and ligand was transferred, and filtered—using a syringe filter, to the solution containing the zirconocene species. The resulting black mixture was stirred for another 10 min before enone (38 mg, 0.2 mmol, 1.0 eq.) and TMSCl (0.127 ml, 1.0 mmol, 5.0 eq.) were sequentially added dropwise over about 1 min for each. Stirring at 0° C. was continued for 15 additional hours, before the reaction was quenched by the addition of 1.5 mL NH₄Cl (sat. aq.) and then 3.0 mL Et₂O. The reaction mixture was partitioned between the aqueous and organic phases, and the aqueous layer extracted by Et₂O (3×10 mL). The combined organic materials were dried (Na₂SO₄), filtered, concentrated, and the resulting yellow residual purified by flash column chromatography (Petrol: Et₂O; 90:10; SiO₂) to give the desired product. (34 mg, 52% yield, 78% ee)

HPLC analysis indicated an enantiomeric excess of 78% [Chiralpak® IB; flow: 1.0 mL/min; hexane/i-PrOH: 98:2; λ=210 nm; major enantiomer tR=19.18 min; minor enantiomer, tR=20.44 min].

¹H NMR (400 MHz, Chloroform-d) δ_{H}/ppm 7.51-7.36 (m, 2H, Ar—H), 7.35-7.26 (m, 5H, Ar—H), 7.22 (dt, J=7.8 Hz, 1.9 Hz, 3H, Ar—H), 2.70-2.52 (m, 2H, PhCH₂), 2.52-2.39 (m, 4H, CH₂), 2.18 (s, 3H, COCH₃), 1.75-1.67 (m, 2H, CH₂), 1.67-1.56 (m, 4H, CH₂), 1.12 (s, 3H, CH₃).

¹³C NMR (101 MHz, Chloroform-d) δ_{C}/ppm 208.5, 142.8, 131.6, 128.5(2C), 128.4(2C), 128.2(2C), 127.6(2C), 125.7, 123.9, 90.1, 80.9, 51.6, 41.6, 38.6, 36.1, 32.6, 30.4, 25.1, 23.4, 20.1.

IR (vₘₐₓ/cm⁻¹, CHCl₃) 3658, 2981, 2388, 1712, 1380, 1154, 755, 667

MS (ESI) m/z calc. for C₂₄H₂₉O [M+H]⁺ 333.2213: found: 333.2216.

[α]²⁰₅₈₉=−1.1 (c 1.0, CHCl₃).

### Example 29—Synthesis of (+)-(R)-4-methyl-4-phenethyldec-9-en-2-one (3v)

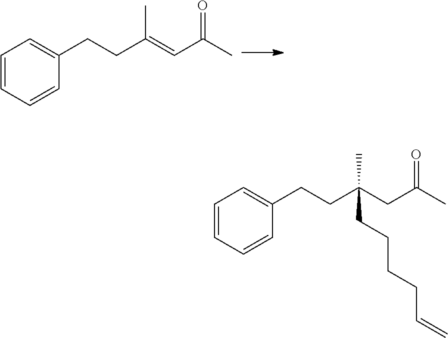

CuCl (1.9 mg, 0.02 mmol, 0.1 eq.), and the phosphoramidite ligand B (11.6 mg, 0.02 mmol) were added to a flame dried round bottom flask containing 1 mL Et₂O under argon and the resulting mixture was stirred at room temperature. After 1 hour, AgOTf (5.6 mg, 0.022 mmol, 0.11 eq.) was added and the mixture was stirred for an additional 15 min.

To a second, flame dried, round bottom flask, containing a stirred solution of 1,5-hexadiene (0.25 ml, 2.0 mmol, 10 eq.) in CH₂Cl₂ (0.4 mL), under an argon atmosphere was added Cp₂ZrHCl (103 mg, 0.4 mmol, 2.0 eq.), and after stirring for 15 min, a clear yellow solution was obtained.

The stirred solution containing the copper and ligand was transferred, and filtered—using a syringe filter, to the solution containing the zirconocene species. The resulting black mixture was stirred for another 10 min before enone (38 mg, 0.2 mmol, 1.0 eq.) and TMSCl (0.127 ml, 1.0 mmol, 5.0 eq.) were sequentially added dropwise over about 1 min for each. Stirring at 0° C. was continued for 15 additional hours, before the reaction was quenched by the addition of 1.5 mL NH₄Cl (sat. aq.) and then 3.0 mL Et₂O. The reaction mixture was partitioned between the aqueous and organic phases, and the aqueous layer extracted by Et₂O (3×10 mL). The combined organic materials were dried (Na₂SO₄), filtered, concentrated, and the resulting yellow residual purified by flash column chromatography (Petrol: Et₂O; 95:5; SiO₂) to give the desired product. (30 mg, 55% yield, 74% ee).

HPLC analysis indicated an enantiomeric excess of 91% [Chiralpak® IA; flow: 1.0 mL/min; hexane/i-PrOH: 99:1; λ=210 nm; major enantiomer tR=4.62 min; minor enantiomer, tR=4.82 min].

¹H NMR (400 MHz, Chloroform-d) δH/ppm 7.23-7.16 (m, 2H, Ar—H), 7.14-7.06 (m, 3H, Ar—H), 5.74 (ddt, J=16.9 Hz, 10.2 Hz, 6.7 Hz, 1H, CH═CH₂), 5.13-4.54 (m, 2H, CH═CH₂), 2.56-2.38 (m, 2H, PhCH₂), 2.33 (s, 2H, CH₂COCH₃), 2.06 (s, 3H, COCH₃), 2.05-1.95 (m, 2H, PhCH₂CH₂), 1.61-1.52 (m, 2H, CH₂), 1.38-1.25 (m, 4H, CH₂), 1.21 (tdd, J=10.3 Hz, 6.2 Hz, 2.8 Hz, 2H, CH₂), 0.97 (s, 3H, CH₃).

¹³C NMR (101 MHz, Chloroform-d) δC/ppm 208.8, 142.9, 139.0, 128.4(4C), 125.7, 114.4, 51.7, 41.6, 39.2, 36.3, 33.7, 32.6, 30.4, 29.6, 25.1, 23.1.

IR (vₘₐₓ/cm⁻¹, CHCl₃) 3658, 2980, 2888, 1382, 1252, 1152, 955.

MS (ESI) m/z calc. for C₁₉H₂₉O [M+H]⁺: 273.2213, found: 273.2215.

[α]²⁰₅₈₉=+0.7° (c 1.0, CHCl₃).

### Example 30—Synthesis of (+)-(S)-4-methyl-4-phenethyl-7-(trimethylsilyl)heptan-2-one (3w)

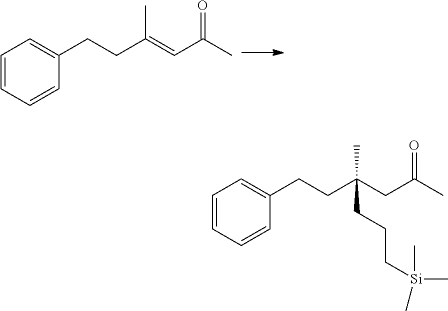

CuCl (1.9 mg, 0.02 mmol, 0.1 eq.), and the phosphoramidite ligand B (11.6 mg, 0.02 mmol) were added to a flame dried round bottom flask containing 1 mL Et₂O under argon and the resulting mixture was stirred at room temperature. After 1 hour, AgOTf (5.6 mg, 0.022 mmol, 0.11 eq.) was added and the mixture was stirred for an additional 15 min.

To a second, flame dried, round bottom flask, containing a stirred solution of allyltrimethylsilane (0.07 ml, 0.5 mmol, 2.5 eq.) in CH₂Cl₂ (0.2 mL), under an argon atmosphere was added Cp₂ZrHCl (103 mg, 0.4 mmol, 2.0 eq.), and after stirring for 15 min, a clear yellow solution was obtained.

The stirred solution containing the copper and ligand was transferred, and filtered—using a syringe filter, to the solution containing the zirconocene species. The resulting black mixture was stirred for another 10 min before enone (38 mg, 0.2 mmol, 1.0 eq.) and TMSCl (0.127 ml, 1.0 mmol, 5.0 eq.) were sequentially added dropwise over about 1 min for each. Stirring at 0° C. was continued for 15 additional hours, before the reaction was quenched by the addition of 1.5 mL NH₄Cl (sat. aq.) and then 3.0 mL Et₂O. The reaction mixture was partitioned between the aqueous and organic phases, and the aqueous layer extracted by Et₂O (3×10 mL). The combined organic materials were dried (Na₂SO₄), filtered, concentrated, and the resulting yellow residual purified by flash column chromatography (Petrol: Et₂O; 95:15; SiO₂) to give the desired product. (25 mg, 42% yield, 88% ee).

HPLC analysis indicated an enantiomeric excess of 91% [Chiralpak® AYH; flow: 1.0 mL/min; hexane/i-PrOH: 99.5:0.5; λ=210 nm; major enantiomer tR=5.73 min; minor enantiomer, tR=6.39 min].

¹H NMR (400 MHz, Chloroform-d) δ_{H}/ppm 7.33-7.24 (m, 2H, Ar—H), 7.23-7.14 (m, 3H, Ar—H), 2.63-2.46 (m, 2H, PhCH₂), 2.41 (s, 2H, CH₂COCH₃), 2.15 (s, 3H, COCH₃), 1.74-1.55 (m, 2H, PhCH₂CH₂), 1.54-1.37 (m, 2H, CH₂), 1.35-1.14 (m, 2H, CH₂), 1.05 (s, 3H, CH₃), 0.67-0.23 (m, 2H, CH₂Si), 0.0 (s, 9H, SiCH₃).

¹³C NMR (101 MHz, Chloroform-d) δ_{C}/ppm 210.4, 144.5, 129.9(2C), 129.9(2C), 127.2, 53.3, 45.4, 43.2, 38.0, 34.2, 32.0, 26.6, 19.5, 19.0, 0.0(3C).

IR (vₘₐₓ/cm⁻¹, CHCl₃) 3658, 2980, 2886, 1382, 1153, 1073, 956.

MS (ESI) m/z calc. for C₁₉H₃₃O²^{⁸}Si [M+H]⁺: 305.2295, found: 305.2296.

[α]²⁰₅₈₉=+0.8° (c 1.0, CHCl₃).

### Example 31—Synthesis of (+)-(R)-8-(benzyloxy)-4-methyl-4-phenethyloctan-2-one (3x)

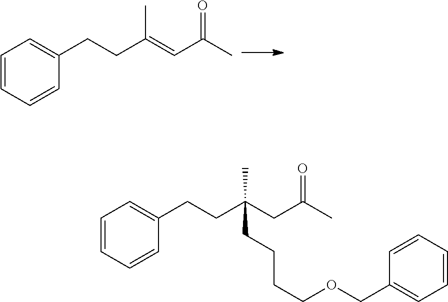

CuCl (1.9 mg, 0.02 mmol, 0.1 eq.), and the phosphoramidite ligand B (11.6 mg, 0.02 mmol) were added to a flame dried round bottom flask containing 1 mL Et₂O under argon and the resulting mixture was stirred at room temperature. After 1 hour, AgOTf (5.6 mg, 0.022 mmol, 0.11 eq.) was added and the mixture was stirred for an additional 15 min.

To a second, flame dried, round bottom flask, containing a stirred solution of 4-benzyloxy-1-butene (0.08 ml, 0.5 mmol, 2.5 eq.) in CH₂Cl₂ (0.2 mL), under an argon atmosphere was added Cp₂ZrHCl (103 mg, 0.4 mmol, 2.0 eq.), and after stirring for 15 min, a clear yellow solution was obtained.

The stirred solution containing the copper and ligand was transferred, and filtered—using a syringe filter, to the solution containing the zirconocene species. The resulting black mixture was stirred for another 10 min before enone (38 mg, 0.2 mmol, 1.0 eq.) and TMSCl (0.127 ml, 1.0 mmol, 5.0 eq.) were sequentially added dropwise over about 1 min for each. Stirring at 0° C. was continued for 15 additional hours, before the reaction was quenched by the addition of 1.5 mL NH₄Cl (sat. aq.) and then 3.0 mL Et₂O. The reaction mixture was partitioned between the aqueous and organic phases, and the aqueous layer extracted by Et₂O (3×10 mL). The combined organic materials were dried (Na₂SO₄), filtered, concentrated, and the resulting yellow residual purified by flash column chromatography (Petrol: Et₂O; 95:5; SiO₂) to give the desired product. (38 mg, 54% yield, 82% ee).

HPLC analysis indicated an enantiomeric excess of 82% % [Chiralpak® IA; flow: 1.0 mL/min; hexane/i-PrOH: 99:1; λ=210 nm; major enantiomer tR=7.57 min; minor enantiomer, tR=8.36 min].

¹H NMR (400 MHz, Chloroform-d) δ_{H}/ppm 7.31-7.23 (m, 4H, Ar—H), 7.23-7.15 (m, 3H, Ar—H), 7.09 (ddt, J=7.0 Hz, 3.6 Hz, 1.4, 3H, Ar—H), 4.43 (s, 2H, OCH₂Ph), 3.41 (t, J=6.5 Hz, 2H, OCH₂), 2.59-2.38 (m, 2H, PhCH₂), 2.33 (s, 2H CH₂COCH₃), 2.05 (s, 3H, CH₂COCH₃), 1.67-1.43 (m, 4H, CH₂), 1.45-1.15 (m, 4H, CH₂), 0.97 (s, 3H, CH₃).

¹³C NMR (101 MHz, Chloroform-d) δ_{C}/ppm 208.8, 142.9, 138.6, 128.4(4C), 127.7(3C), 127.5(2C), 125.7, 72.9, 70.2, 51.6, 41.6, 39.2, 36.2, 32.6, 30.4 (2C), 25.1, 20.4.

IR (vₘₐₓ/cm⁻¹, CHCl₃) 3659, 2981, 2885, 1510, 1381, 1165, 956, 741.

MS (ESI) m/z calc. for C₂₄H₃₃O₂[M+H]⁺: 353.2475, found: 353.2476.

[α]²⁰₅₈₉=+1.0° (c 1.0, CHCl₃).

### Example 32—Synthesis of (+)-(R)-8-((tert-butyldimethylsilyl)oxy)-4-methyl-4-phenethyloctan-2-one (3y)

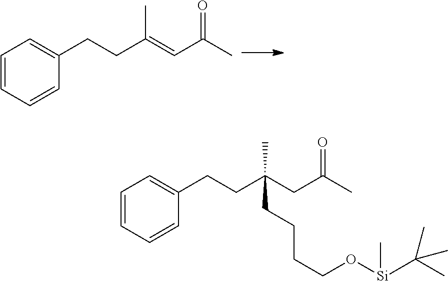

CuCl (1.9 mg, 0.02 mmol, 0.1 eq.), and the phosphoramidite ligand B (11.6 mg, 0.02 mmol) were added to a flame dried round bottom flask containing 1 mL Et₂O under argon and the resulting mixture was stirred at room temperature. After 1 hour, AgOTf (5.6 mg, 0.022 mmol, 0.11 eq.) was added and the mixture was stirred for an additional 15 min.

To a second, flame dried, round bottom flask, containing a stirred solution of 4-[(tert-butyldimethylsilyl)oxy]-1-butene (0.11 ml, 0.5 mmol, 2.5 eq.) in CH₂Cl₂ (0.2 mL), under an argon atmosphere was added Cp₂ZrHCl (103 mg, 0.4 mmol, 2.0 eq.), and after stirring for 15 min, a clear yellow solution was obtained.

The stirred solution containing the copper and ligand was transferred, and filtered—using a syringe filter, to the solution containing the zirconocene species. The resulting black mixture was stirred for another 10 min before enone (38 mg, 0.2 mmol, 1.0 eq.) and TMSCl (0.127 ml, 1.0 mmol, 5.0 eq.) were sequentially added dropwise over about 1 min for each. Stirring at 0° C. was continued for 15 additional hours, before the reaction was quenched by the addition of 1.5 mL NH₄Cl (sat. aq.) and then 3.0 mL Et₂O. The reaction mixture was partitioned between the aqueous and organic phases, and the aqueous layer extracted by Et₂O (3×10 mL). The combined organic materials were dried (Na₂SO₄), filtered, concentrated, and the resulting yellow residual purified by flash column chromatography (Petrol: Et₂O; 95:5; SiO₂) to give the desired product. (50 mg, 71% yield, 91% ee).

HPLC analysis indicated an enantiomeric excess of 91% [Chiralpak® IB; flow: 1.0 mL/min; hexane/i-PrOH: 99.95:0.05; λ=210 nm; minor enantiomer tR=16.30 min; major enantiomer, tR=16.65 min].

¹H NMR (400 MHz, Chloroform-d) δ_{H}/ppm 7.26-7.16 (m, 2H, Ar—H), 7.16-7.07 (m, 3H, Ar—H), 3.57 (t, J=6.4 Hz, 2H, CH₂O), 2.54-2.40 (m, 2H, PhCH₂), 2.35 (s, 2H, CH₂COCH₃), 2.08 (s, 3H, COCH₃), 1.68-1.52 (m, 2H, PhCH₂CH₂), 1.50-1.41 (m, 2H, CH₂), 1.41-1.32 (m, 2H, CH₂), 1.31-1.19 (m, 2H, CH₂), 0.99 (s, 3H, CH₃), 0.84 (s, 9H, C (CH₃)₃), −0.0 (s, 6H, SiCH₃).

¹³C NMR (101 MHz, Chloroform-d) δ_{C}/ppm 208.7, 142.9, 128.4(4C), 125.7, 63.1, 51.6, 41.6, 39.2, 36.3, 33.6, 32.6, 30.4, 26.0, 25.1, 20.0, 18.4, −5.2(3C).

IR (vₘₐₓ/cm⁻¹, CHCl₃) 3658, 2980, 2888, 1383, 1252, 1073, 955.

MS (ESI) m/z calc. for C₂₃H₄₁O₂²^{⁸}Si [M+H]⁺: 377.2870, found: 377.2877.

[α]²⁰₅₈₉=+1.0° (c 1.0, CHCl₃).

### Example 33—Synthesis of (−)-(R)-4-(cyclohexylmethyl)-6-(4-methoxyphenyl)-4-methylhexan-2-one (3z)

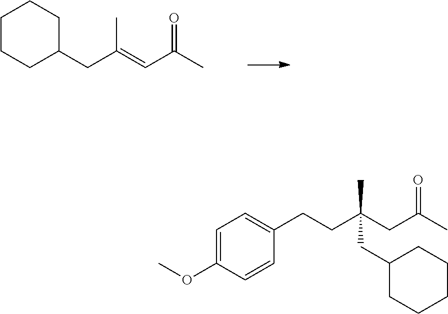

CuCl (1.9 mg, 0.02 mmol, 0.1 eq.), and the phosphoramidite ligand B (11.6 mg, 0.02 mmol) were added to a flame dried round bottom flask containing 1 mL Et₂O under argon and the resulting mixture was stirred at room temperature. After 1 hour, AgOTf (5.6 mg, 0.022 mmol, 0.11 eq.) was added and the mixture was stirred for an additional 15 min.

To a second, flame dried, round bottom flask, containing a stirred solution of 1-methoxy-4-vinylbenzene (0.07 ml, 0.5 mmol, 2.5 eq.) in CH₂Cl₂ (0.2 mL), under an argon atmosphere was added Cp₂ZrHCl (103 mg, 0.4 mmol, 2.0 eq.), and after stirring for 15 min, a clear solution was obtained.

The stirred solution containing the copper and ligand was transferred, and filtered—using a syringe filter, to the solution containing the zirconocene species. The resulting black mixture was stirred for another 10 min before enone (36 mg, 0.2 mol, 1.0 eq.) and TMSCl (0.127 ml, 1.0 mmol, 5.0 eq.) were sequentially added dropwise over about 1 min for each. Stirring at 0° C. was continued for 15 additional hours, before the reaction was quenched by the addition of 1.5 mL NH₄Cl (sat. aq.) and then 3.0 mL Et₂O. The reaction mixture was partitioned between the aqueous and organic phases, and the aqueous layer extracted by Et₂O (3×10 mL). The combined organic materials were dried (Na₂SO₄), filtered, concentrated, and the resulting yellow residual purified by flash column chromatography (Petrol: Et₂O; 95:5; SiO₂) to give the desired product. (15 mg, 24% yield, 88% ee).

HPLC analysis indicated an enantiomeric excess of 88% [Chiralpak® IA; flow: 1.0 mL/min; hexane/i-PrOH: 99.5:0.5; λ=210 nm; minor enantiomer tR=11.27 min; major enantiomer, tR=11.73 min].

¹H NMR (400 MHz, Chloroform-d) δ_{H}/ppm 7.18-7.04 (m, 2H, Ar—H), 6.90-6.69 (m, 2H, Ar—H), 3.78 (s, 3H, OCH₃), 2.48 (td, J=9.2 Hz, 2.3 Hz, 2H, PhCH₂), 2.42 (s, 2H, CH₂COCH₃), 2.13 (s, 3H, COCH₃), 1.80-1.51 (m, 6H, CH, CH₂), 1.37-1.27 (m, 3H, CH₂), 1.27-1.09 (m, 3H, CH₂), 1.09-0.91 (m, 6H, CH₂, CH₃).

¹³C NMR (101 MHz, Chloroform-d) δ_{C}/ppm 208.8, 157.7, 135.0, 129.2(2C), 113.8(2C), 55.3, 52.1, 47.1, 42.2, 36.9, 36.0(2C), 33.5, 32.7, 29.6, 26.6 (2C), 26.2, 25.5.

IR (vₘₐₓ/cm⁻¹, CHCl₃) 3658, 2980, 2889, 1383, 1251, 1152, 1073, 955, 819.

MS (ESI) m/z calc. for C₂₁H₃₃O₂ [M+H]⁺: 317.2475, found: 317.2477.

[α]²⁰₅₈₉=−1.7° (c 1.0, CHCl₃).

### Example 34—Synthesis of (+)-(R)-4-(cyclohexylmethyl)-4-methyl-8-phenyloctan-2-one (3aa)

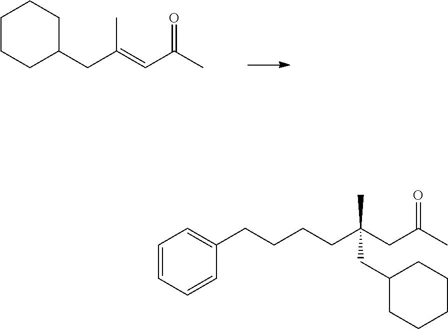

CuCl (1.9 mg, 0.02 mmol, 0.1 eq.), and the phosphoramidite ligand B (11.6 mg, 0.02 mmol) were added to a flame dried round bottom flask containing 1 mL Et₂O under argon and the resulting mixture was stirred at room temperature. After 1 hour, AgOTf (5.6 mg, 0.022 mmol, 0.11 eq.) was added and the mixture was stirred for an additional 15 min.

To a second, flame dried, round bottom flask, containing a stirred solution of 4-phenyl-1 butene (0.08 ml, 0.5 mmol, 2.5 eq.) in CH₂Cl₂ (0.2 mL), under an argon atmosphere was added Cp₂ZrHCl (103 mg, 0.4 mmol, 2.0 eq.), and after stirring for 15 min, a clear yellow solution was obtained.

The stirred solution containing the copper and ligand was transferred, and filtered—using a syringe filter, to the solution containing the zirconocene species. The resulting black mixture was stirred for another 10 min before enone (36 mg, 0.2 mmol, 1.0 eq.) and TMSCl (0.127 ml, 1.0 mmol, 5.0 eq.) were sequentially added dropwise over about 1 min for each. Stirring at 0° C. was continued for 15 additional hours, before the reaction was quenched by the addition of 1.5 mL NH₄Cl (sat. aq.) and then 3.0 mL Et₂O. The reaction mixture was partitioned between the aqueous and organic phases, and the aqueous layer extracted by Et₂O (3×10 mL). The combined organic materials were dried (Na₂SO₄), filtered, concentrated, and the resulting yellow residual purified by flash column chromatography (Petrol: Et₂O; 95:5; SiO₂) to give the desired product. (23 mg, 35% yield, 92% ee).

HPLC analysis indicated an enantiomeric excess of 92% [Chiralpak® IE; flow: 0.8 mL/min; hexane/i-PrOH: 99.5:0.5; λ=210 nm; major enantiomer tR=9.96 min; minor enantiomer, tR=10.97 min].

¹H NMR (400 MHz, Chloroform-d) δ_{H}/ppm 7.26-7.14 (m, 2H, Ar—H), 7.14-7.05 (m, 3H, Ar—H), 2.67-2.45 (m, 2H, PhCH₂), 2.25 (s, 2H, CH₂COCH₃), 2.02 (s, 3H, COCH₃), 1.73-1.44 (m, 8H, CH CH₂), 1.37-1.26 (m, 2H, CH₂), 1.25-1.00 (m, 7H, CH₂), 0.89 (s, 3H, CH₃), 0.88-0.80 (m, 2H, CH₂).

¹³C NMR (101 MHz, Chloroform-d) δ_{C}/ppm 209.1, 142.7, 128.4(2C), 128.2(2C), 125.6, 52.2, 47.1, 39.6, 36.8, 35.9, 35.9, 33.4(2C), 32.6, 32.2, 26.6, 26.3, 25.5(2C), 23.6.

IR (vₘₐₓ/cm⁻¹, CHCl₃) 3658, 2981, 1715, 1451, 1381, 1152, 954, 698.

MS (ESI) m/z calc. for C₂₂H₃₄O²³Na [M+Na]⁺: 337.2502 found: 337.2502.

[α]²⁰₅₈₉=+0.6° (c 1.0, CHCl₃).

All references, including publications, patent applications, and patents, cited herein are hereby incorporated by reference in their entirety and to the same extent as if each reference were individually and specifically indicated to be incorporated by reference and were set forth in its entirety herein (to the maximum extent permitted by law).

All headings and sub-headings are used herein for convenience only and should not be construed as limiting the invention in any way.

The use of any and all examples, or exemplary language (e.g., “such as”) provided herein, is intended merely to better illuminate the invention and does not pose a limitation on the scope of the invention unless otherwise paragraphed. No language in the specification should be construed as indicating any non-paragraphed element as essential to the practice of the invention.

The citation and incorporation of patent documents herein is done for convenience only and does not reflect any view of the validity, patentability, and/or enforceability of such patent documents.

This invention includes all modifications and equivalents of the subject matter recited in the paragraphs appended hereto as permitted by applicable law.

### REFERENCES

1. Selected reviews: (a) E. J. Corey and A. Guzman-Perez, Angew. Chem., Int. Ed., 1998, 37, 388-401; (b) J. Christoffers and A. Baro, Angew. Chem., Int. Ed., 2003, 42, 1688-1690; (c) C. J. Douglas and L. E. Overman, Proc. Natl. Acad. Sci. U.S.A, 2004, 101, 5363-5367; (d) B. M. Trost and C. Jiang, Synthesis, 2006, 369-396; (e) C. Hawner and A. lexakis, Chem. Commun., 2010, 46, 7295-7306; (f) K. W. Quasdorf and L. E. Overman, Nature, 014, 516, 181-191; (g) M. Buschleb, S. Dorich, S. Hanessian, D. Tao, K. B. Schenthal and L. E. Overman, Angew. Chem., Int. Ed., 2016, 55, 4156-4186.
2. For detailed discussion see: (a) J. P. Das and I. Marek, Chem. Commun., 2011, 47, 4593-4623; (b) I. Marek, Y. Minko, M. Pasco, T. Mejuch, N. Gilboa, H. Chechik and J. P. Das, J. Am. Chem. Soc., 2014, 136, 2682-2694.
3. 3(a) Copper-Catalyzed Asymmetric Synthesis, ed. A. Alexakis, N. Krause and S. Woodward, Wiley-VCH Verlag GmbH & Co. KGaA, 2014; (b) B. Macia, in Progress in Enantioselective Cu(I)-Catalyzed Formation of Stereogenic Centers, ed. S. R. Harutyunyan, Springer, 2016, vol. 58, pp. 41-98.
4. (a) M. D'Augustin, L. Palais and A. Alexakis, Angew. Chem., Int. Ed., 2005, 44, 1376-1378; (b) D. Martin, S. Kehrli, M. D'Augustin, H. Clavier, M. Mauduit and A. Alexakis, J. Am. Chem. Soc., 2006, 128, 8416-8417; (c) C. Hawner, K. Li, V. Cirriez and A. Alexakis, Angew. Chem., Int. Ed., 2008, 47, 8211-8214; (d) M. Tissot, D. Poggiali, H. Henon, D. Muller, L. Guenee, M. Mauduit and A. Alexakis, Chem.-Eur. J., 2012, 18, 8731-8747.
5. 5(a) A. W. Hird and A. H. Hoveyda, J. Am. Chem. Soc., 2005, 127, 14988-14989; (b) K.-S. Lee, M. K. Brown, A. W. Hird and A. H. Hoveyda, J. Am. Chem. Soc., 2006, 128, 7182-7184; (c) T. L. May, M. K. Brown and A. H. Hoveyda, Angew. Chem., Int. Ed., 2008, 47, 7358-7362; (d) T. L. May, J. A. Dabrowski and A. H. Hoveyda, J. Am. Chem. Soc., 2011, 133, 736-739.
6. (a) J. A. Dabrowski, M. T. Villaume and A. H. Hoveyda, Angew. Chem., Int. Ed., 2013, 52, 8156-8159; (b) K. P. McGrath and A. H. Hoveyda, Angew. Chem., Int. Ed., 2014, 53, 1910-1914.
7. Examples of Cu-catalyzed ACA to form quaternary centres in natural product synthesis: (a) M. Vuagnoux-d'Augustin and A. Alexakis, Chem.-Eur. J., 2007, 13, 9647-9662; (b) K. M. Peese and D. Y. Gin, Chem.-Eur. J., 2008, 14, 1654-1665; (c) M. K. Brown and A. H. Hoveyda, J. Am. Chem. Soc., 2008, 130, 12904-12906; (d) S. Kehrli, D. Martin, D. Rix, Mauduit and A. Alexakis, Chem.-Eur. J., 2010, 16, 9890-9904; (e) A. Mendoza, Y. Ishihara and P. S. Baran, Nat. Chem., 2012, 4, 21-25; (f) Y. Ishihara, A. Mendoza and P. S. Baran, Tetrahedron, 2013, 69, 5685-5701; (g) S. G. Krasutsky, S. H. Jacobo, S. R. Tweedie, R. Krishnamoorthy and A. S. Filatov, Org. Process Res. Dev., 2015, 19, 284-289; (h) P. Cottet, C. Bleschke, M. G. Capdevila, M. Tissot and A. Alexakis, Adv. Synth. Catal., 2016, 358, 417-425.
8. Y. Minko, M. Pasco, L. Lercher, M. Botoshansky and I. Marek, Nature, 2012, 490, 522-526.
9. J. Wu, D. M. Mampreian and A. H. Hoveyda, J. Am. Chem. Soc., 2005, 127, 4584-4585.
10. X. Zeng, J. J. Gao, J. J. Song, S. Ma, J. N. Desrosiers, J. A. Mulder, S. Rodriguez, M. A. Herbage, N. Haddad, B. Qu, K. R. Fandrick, N. Grinberg, H. Lee, X. Wei, N. K. Yee and C. H. Senanayake, Angew. Chem., Int. Ed., 2014, 53, 12153-12157.
11. (a) E. Fillion and A. Wilsily, J. Am. Chem. Soc., 2006, 128, 2774-2775; (b) S. J. Mahoney, A. M. Dumas and E. Fillion, Org. Lett., 2009, 11, 5346-5349; (c) A. Wilsily and E. Fillion, J. Org. Chem., 2009, 74, 8583-8594; (d) E. Fillion, A. Wilsily and T. Lou, Synthesis, 2009, 2066-2072; (e) A. M. Dumas and E. Fillion, Acc. Chem. Res., 2010, 440-454.
12. (a) K. Endo, D. Hamada, S. Yakeishi and T. Shibata, Angew. Chem., Int. Ed., 2013, 52, 606-610; (b) K. Endo, S. Yakeishi, R. Takayama and T. Shibata, Chem.-Eur. J., 2014, 20, 8893-8897.
13. R. M. Maksymowicz, P. M. Roth and S. P. Fletcher, Nat. Chem., 2012, 4, 649-654.
14. R. M. Maksymowicz, A. J. Bissette and S. P. Fletcher, Chem.-Eur. J., 2015, 21, 5668-5678.
15. M. Sidera, P. M. Roth, R. M. Maksymowicz and S. P. Fletcher, Angew. Chem., Int. Ed., 2013, 52, 7995-7999.
16. P. M. Roth, M. Sidera, R. M. Maksymowicz and S. P. Fletcher, Nat. Protoc., 2014, 9, 104-111.
17. P. M. Roth and S. P. Fletcher, Org. Lett., 2015, 17, 912-915.

1. A compound of formula (I) and salts thereof, 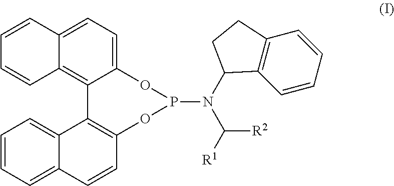
wherein
R¹ and R² are the same or different and selected from a C₂ to C₁₂ alkyl group; or
R¹ and R² together with the carbon atom to which they are attached form a C₇ to C₂₀ cycloalkyl group.

2. A compound according to claim 1 wherein R¹ and R² are the same or different and selected from a C₂ to C₁₀ alkyl group; or
R¹ and R² together with the carbon atom to which they are attached form a C₇ to C₁₀ cycloalkyl group.

3. A compound according to claim 1 wherein R¹ and R² are the same or different and selected from a C₂ to C₆ alkyl group; or
R¹ and R² together with the carbon atom to which they are attached form a C₇ to C₉ cycloalkyl group.

4. A compound according to claim 1 wherein R¹ and R² are the same or different and selected from a C₄ alkyl group; or
R¹ and R² together with the carbon atom to which they are attached form a C₇ to C₉ cycloalkyl group.

5. A compound according to claim 1 wherein R¹ and R² are both unbranched alkyl groups.

6. A compound according to claim 1 wherein R¹ and R² are both n-butyl.

7. A compound according to claim 1 selected from:

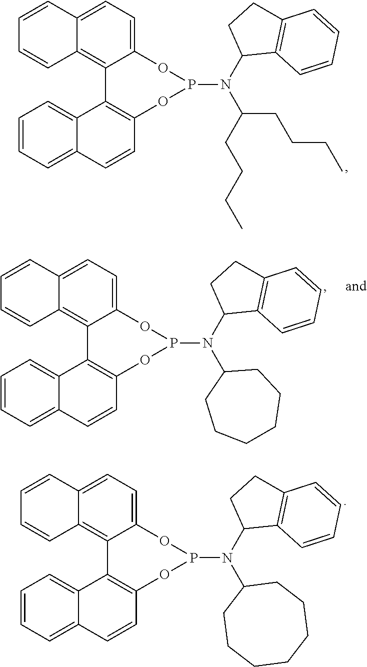

8. A compound according to claim 1 wherein the compound is non-racemic.

9. A compound according to claim 1 wherein the compound is the (R,R)- or (S,S)-diastereoisomer.

10. A catalytic complex comprising a metal, a counter ion and a compound according to claim 1.

11. A catalytic complex according to claim 10 wherein the metal is copper and the counterion is triflate.

12. A process comprising contacting a hydrometallated first compound with a second compound comprising a conjugated π-bond system which is capable of undergoing a 1,4-conjugate addition reaction or a 1,6-conjugate addition reaction in the presence of a compound according to claim 1, or a catalyst according to claim 10, to provide a stereocentre in stereoisomeric excess.

13. The process according to claim 12 wherein the stereocentre is an all-carbon quaternary stereocentre.

14. The process according to claim 12 wherein the stereoisomeric excess is greater than 90%.

15. The process according to claim 12 wherein the stereocentre is part of an acyclic system.

16. The process of claim 12, further comprising contacting a first compound comprising an alkene bond with a hydrometallating agent, wherein the first compound and the hydrometallating agent are contacted under conditions such that the first compound is hydrometallated by said hydrometallating agent.

17. The process of claim 16, wherein the hydrometallated first compound and the second compound are contacted under conditions such that they undergo an asymmetric 1,4-conjugate addition reaction or an asymmetric 1,6-conjugate addition reaction in which a carbon atom of said hydrometallated first compound binds to the carbon atom at said 4-position or said 6-position of the second compound

18. The process of claim 16, wherein the first compound is a terminal alkene.

19. The process of claim 16, wherein the first compound is a straight or branched alkene compound having from 2 to 30 carbon atoms unsubstituted or substituted with one or more substituent.

20. The process of claim 12, wherein the step of contacting further comprising a silyl halide.
